(19) United States
(12) Patent Application Publication
(10) Pub. No.: US 2026/0147585 A1
(43) Pub. Date: May 28, 2026

(54) SYSTEM CONFIGURATION DERIVATION DEVICE, SYSTEM CONFIGURATION DERIVATION METHOD, AND NON-TRANSITORY COMPUTER-READABLE RECORDING MEDIUM

(71) Applicant: NEC Corporation, Tokyo (JP)

(72) Inventors: Takuya KUWAHARA, Tokyo (JP); Takayuki Kuroda, Tokyo (JP); Toshiki Watanabe, Tokyo (JP)

(73) Assignee: NEC Corporation, Tokyo (JP)

(21) Appl. No.: 19/386,309

(22) Filed: Nov. 12, 2025

(30) Foreign Application Priority Data
Nov. 27, 2024 (JP) 2024-206437

(51) Int. Cl. G06F 9/445; G06F 9/50; G06F 11/30

(52) U.S. Cl. CPC G06F 9/44505; G06F 9/505; G06F 11/3051

(57) ABSTRACT

A method includes a configuration concretization unit acquiring an abstract configuration and a resource allocation model input as requirement data and concretizing the abstract configuration and the resource allocation model in a stepwise manner in accordance with a predetermined rule to generate a system configuration satisfying the requirement data, and a resource allocation unit acquiring the resource allocation model as input and outputs a resource usage status in accordance with the resource allocation model.

This application is based upon and claims the benefit of priority from Japanese Patent Application No. 2024-206437, filed on Nov. 27, 2024, the disclosure of which is incorporated herein in its entirety by reference.

### TECHNICAL FIELD

The present disclosure relates to a system configuration derivation device, a system configuration derivation method, and a program.

### BACKGROUND ART

When an information and communication technology (ICT) system is constructed for the purpose of service operation or the like, work of designing a system configuration is required. In the work of designing the system configuration, it is necessary to construct system components, necessary to satisfy requirements (hereinafter, “system requirements”) required for a desired system, and connection relationships thereof (hereinafter, these will be collectively referred to as “system configurations”) without shortage and to correctly set all setting items necessary for normal operation of the entire system, which is work that requires a lot of labor in some cases.

A technique for automating the above-described design process, that is, the process of concretizing the system configuration with the system requirements is an automated design technique. Although many existing automated design techniques limit problems to a specific domain of an ICT system, for example, arrangement of a network path or a calculation resource, and then perform automated design by solving a certain type of optimization problem or the like, techniques for handling generic requirement descriptions have also been studied.

For example, a technique for automatically deriving a system configuration based on functional requirements described using a generic system configuration information model in a graph-like format is described in JP 6989014 B1 and Takayuki Kuroda, Takuya Kuwahara, Takashi Maruyama, Kozo Satoda, Hideyuki Shimonishi, Takao Osaki and Katsushi Matsuda, “Weaver: A Novel Configuration Designer for IT/NW Services in Heterogeneous Environments”, 2019 IEEE Global Communications Conference (GLOBECOM), 2019, pp. 1-6. According to the technique described in JP 6989014 B1 and Takayuki Kuroda, Takuya Kuwahara, Takashi Maruyama, Kozo Satoda, Hideyuki Shimonishi, Takao Osaki and Katsushi Matsuda, “Weaver: A Novel Configuration Designer for IT/NW Services in Heterogeneous Environments”, 2019 IEEE Global Communications Conference (GLOBECOM), 2019, pp. 1-6, it is possible to perform automated design using generic and multifaceted requirements as input by preparing necessary models.

The requirement that is possible to be described by the generic model described in Takayuki Kuroda, Takuya Kuwahara, Takashi Maruyama, Kozo Satoda, Hideyuki Shimonishi, Takao Osaki and Katsushi Matsuda, “Weaver: A Novel Configuration Designer for IT/NW Services in Heterogeneous Environments”, 2019 IEEE Global Communications Conference (GLOBECOM), 2019, pp. 1-6 is one (hereinafter referred to as an “abstract configuration”) mainly specified by a graph-like representation in which parts such as functions and devices are represented as nodes, and relationships among the nodes are represented by edges (directed edges). For example, a requirement “Communication between two servers by Transmission Control Protocol (TCP) is possible” is represented as an abstract configuration in which nodes corresponding to the respective servers are connected by an edge representing that “TCP communication possible”. A method described in Takayuki Kuroda, Takuya Kuwahara, Takashi Maruyama, Kozo Satoda, Hideyuki Shimonishi, Takao Osaki and Katsushi Matsuda, “Weaver: A Novel Configuration Designer for IT/NW Services in Heterogeneous Environments”, 2019 IEEE Global Communications Conference (GLOBECOM), 2019, pp. 1-6 is a mechanism for automatically deriving a method for concretizing the abstract “TCP communication possible” edge included in the above abstract configuration. (Hereinafter, nodes and edges are collectively referred to as “entities”)

It should be noted that the automated design method described in Takayuki Kuroda, Takuya Kuwahara, Takashi Maruyama, Kozo Satoda, Hideyuki Shimonishi, Takao Osaki and Katsushi Matsuda, “Weaver: A Novel Configuration Designer for IT/NW Services in Heterogeneous Environments”, 2019 IEEE Global Communications Conference (GLOBECOM), 2019, pp. 1-6 does not concretize given requirements at once. In the above automated design method, peripheral configuration information (hereinafter referred to as an “expected configuration”) is held as data for model data (hereinafter referred to as a “component model”) representing related information with respect to a type of an entity (hereinafter referred to as a “type”), the peripheral configuration information being necessary for the entity having the type to normally function as a part of a system, and the peripheral configuration information is sequentially applied to abstract configurations representing requirements, or types of nodes and edges are replaced with more concrete types for stepwise conversion into a concrete abstract configuration.

Here, “applying an expected configuration” is an operation performed on an abstract node or edge (hereinafter referred to as a “unit requirement”) included in an abstract configuration, and indicates adding a structure corresponding to the expected configuration to the abstract configuration with respect to the unit requirement not including the expected configuration.

In contrast to the operation of “applying an expected configuration”, an operation of replacing types of entities with more concrete types is referred to as “type refinement”. The operation of applying the expected configuration to the entities and the operation of refining the types are collectively referred to as “concretization” operations.

The automated design method described in Takayuki Kuroda, Takuya Kuwahara, Takashi Maruyama, Kozo Satoda, Hideyuki Shimonishi, Takao Osaki and Katsushi Matsuda, “Weaver: A Novel Configuration Designer for IT/NW Services in Heterogeneous Environments”, 2019 IEEE Global Communications Conference (GLOBECOM), 2019, pp. 1-6 is possible to be said to be a method of repeatedly concretizing input functional requirements to obtain an abstract configuration in which all unit requirements contained in the requirements are resolved. The abstract configuration obtained in this manner is possible to be considered as a completely concretized system configuration not including any abstract element.

As described above, it is possible to perform automated design by stepwise concretization of functional requirements represented in abstract configurations.

The above-described system requirements are possible to include information regarding “resources” that is possible to be used for system construction in addition to information regarding functions and the like that are desired to be implemented as services.

For example, it is possible to specify, as a requirement, machines possessed by a service operator as information processing devices in which an application for operating a service is deployed, thereby designing a system configuration in which the application is deployed in the specified machines.

The above example is a specific example of physical resources, and the resources handled in the present disclosure also include virtual and/or logical resources.

For example, it is necessary to allocate addresses (IP addresses) for accessing from the outside to services that need to be published through a network, but there is a limitation on the IP addresses that are possible to be specified. Therefore, by specifying a set of addresses available to the service operator as allocable IP addresses, it is possible to design a system configuration in which an address appropriately selected from among available addresses is specified for the service.

When requirements including available resources are handled in a framework of the automated design described in Takayuki Kuroda, Takuya Kuwahara, Takashi Maruyama, Kozo Satoda, Hideyuki Shimonishi, Takao Osaki and Katsushi Matsuda, “Weaver: A Novel Configuration Designer for IT/NW Services in Heterogeneous Environments”, 2019 IEEE Global Communications Conference (GLOBECOM), 2019, pp. 1-6, there is a problem that calculation time increases by the number of specified resources. In particular, in a large-scale system, it is not rare that several hundreds of machines are specified, and it is common that candidates exist in several tens of thousands of available IP addresses.

Considering that the automated design described in Takayuki Kuroda, Takuya Kuwahara, Takashi Maruyama, Kozo Satoda, Hideyuki Shimonishi, Takao Osaki and Katsushi Matsuda, “Weaver: A Novel Configuration Designer for IT/NW Services in Heterogeneous Environments”, 2019 IEEE Global Communications Conference (GLOBECOM), 2019, pp. 1-6 is applied to the case described above while handling each resource as a node of a graph-like structure, design efficiency is extremely deteriorated due to the following two problems.
(1) If a data structure itself treated as the abstract configuration in a design process is large, calculation time of the entire search process for generating many abstract configurations as configuration proposal candidates becomes long.
(2) If all use modes of a large number of resources are generated as design candidates one by one, the number of design candidates that appear during the search process becomes enormous.

Although these problems are problems caused by handling resources as individual nodes one by one, simply treating the resources collectively is also inappropriate since it is necessary to output the use modes of the individual resources as the system configuration eventually.

### SUMMARY

According to one aspect of the present disclosure, a system configuration derivation device includes a configuration concretization unit that acquires an abstract configuration and a resource allocation model input as requirement data and concretizes the abstract configuration and the resource allocation model in a stepwise manner in accordance with a predetermined rule to generate a system configuration satisfying the requirement data, and a resource allocation unit that acquires the resource allocation model as input and outputs a resource usage status in accordance with the resource allocation model, in a case where the abstract configuration is a configuration information of a system capable of including a configuration that is abstract and represented as graph data connecting a node and an edge, a resource is a resource required for normal operation of a constituent element of the system, a consumer is the constituent element requiring the resource, a resource group is an object corresponding to a set of the resources, the resource usage status is a data defining the resource used by the consumer and the resources included in the resource group, and the resource allocation model is a data indicating a correspondence between the consumer included in the abstract configuration and the resource group to be allocated to the consumer.

According to one aspect of the present disclosure, a system configuration derivation method includes acquiring, by a computer, an abstract configuration and a resource allocation model input as requirement data, and concretizing the abstract configuration and the resource allocation model in a stepwise manner in accordance with a predetermined rule to generate a system configuration satisfying the requirement data, and acquiring, by the computer, the resource allocation model as input and outputting a resource usage status in accordance with the resource allocation model, in a case where the abstract configuration is a configuration information of a system capable of including a configuration that is abstract and represented as graph data connecting a node and an edge, a resource is a resource required for normal operation of a constituent element of the system, a consumer is the constituent element requiring the resource, a resource group refers to an object corresponding to a set of the resources, the resource usage status is a data defining the resource used by the consumer and the resources included in the resource group, and the resource allocation model is a data indicating a correspondence between the consumer included in the abstract configuration and the resource group to be allocated to the consumer.

According to one aspect of the present disclosure, a program causes a computer to execute processing of acquiring, by a computer, an abstract configuration and a resource allocation model input as requirement data, and concretizing the abstract configuration and the resource allocation model in a stepwise manner in accordance with a predetermined rule to generate a system configuration satisfying the requirement data, and acquiring, by the computer, the resource allocation model as input and outputting a resource usage status in accordance with the resource allocation model, in a case where the abstract configuration is a configuration information of a system capable of including a configuration that is abstract and represented as graph data connecting a node and an edge, a resource is a resource required for normal operation of a constituent element of the system, a consumer is the constituent element requiring the resource, a resource group is an object corresponding to a set of the resources, the resource usage status is a data defining the resource used by the consumer and the resources included in the resource group, and the resource allocation model is a data indicating a correspondence between the consumer included in the abstract configuration and the resource group to be allocated to the consumer.

### BRIEF DESCRIPTION OF THE DRAWINGS

FIG. 1 is a block diagram illustrating a configuration example of a system configuration derivation device according to a first example embodiment;

FIG. 2 is a block diagram illustrating a configuration example of a system configuration derivation device according to a second example embodiment;

FIG. 3 is a flowchart illustrating operation of a configuration concretization unit of the system configuration derivation device according to the first example embodiment;

FIG. 4A is a first flowchart for describing operation of a resource allocation unit of the system configuration derivation device according to the first example embodiment;

FIG. 4B is a second flowchart for describing the operation of the resource allocation unit of the system configuration derivation device according to the first example embodiment;

FIG. 5A is a first explanatory diagram illustrating an example of a configuration proposal according to the first example embodiment;

FIG. 5B is an explanatory diagram illustrating an example of a resource allocation model according to the first example embodiment;

FIG. 6 is an explanatory diagram illustrating an example of an expected configuration defined in a component model according to the first example embodiment;

FIG. 7A is a first explanatory diagram illustrating an example of concretization by the expected configuration according to the first example embodiment;

FIG. 7B is a second explanatory diagram illustrating an example of concretization by the expected configuration according to the first example embodiment;

FIG. 7C is a third explanatory diagram illustrating an example of concretization by the expected configuration according to the first example embodiment;

FIG. 8A is a first explanatory diagram illustrating a resource allocation model to which a proxy resource group is added by the resource allocation unit according to the first example embodiment;

FIG. 8B is a second explanatory diagram illustrating a resource allocation model to which a proxy resource group is added by the resource allocation unit according to the first example embodiment;

FIG. 9 is an explanatory diagram illustrating an example of an abstract configuration input to a system configuration derivation device according to the second example embodiment;

FIG. 10 is an explanatory diagram illustrating a configuration proposal obtained as a result of converting an abstract configuration by a resource data extraction unit according to the second example embodiment;

FIG. 11 is an explanatory diagram illustrating an example of an abstract configuration and a resource usage status input to a resource data reflection unit according to the second example embodiment;

FIG. 12 is an explanatory diagram illustrating an abstract configuration obtained as a result of converting a configuration proposal illustrated in FIG. 11 by the resource data reflection unit according to the second example embodiment;

FIG. 13 is a block diagram illustrating a configuration example of a system configuration derivation device according to a third example embodiment;

FIG. 14 is a flowchart illustrating an example of operation of the system configuration derivation device according to the third example embodiment; and

FIG. 15 is a diagram illustrating an example of a hardware configuration of the system configuration derivation device according to each example embodiment.

### EXAMPLE EMBODIMENT

Hereinafter, a system configuration derivation device according to each example embodiment of the present disclosure will be described with reference to the drawings. In the drawings used in the following description, configurations of portions not related to the present disclosure may be omitted and not illustrated. In all the drawings, the same or corresponding configurations are denoted by the same reference signs, and the common description may be omitted.

As described in the following example embodiments, the present disclosure proposes to include, in a configuration proposal, a “resource allocation model” that handles resources collectively as a “set” and at the same time holds information on correspondences with consumers who use the resources.

That is, in addition to an abstract configuration, data (=the resource allocation model) representing a “resource usage status (=the correspondences with the consumers)” with respect to entities related to the resources is included as data representing a configuration proposal in automated design described in Takayuki Kuroda, Takuya Kuwahara, Takashi Maruyama, Kozo Satoda, Hideyuki Shimonishi, Takao Osaki and Katsushi Matsuda, “Weaver: A Novel Configuration Designer for IT/NW Services in Heterogeneous Environments”, 2019 IEEE Global Communications Conference (GLOBECOM), 2019, pp. 1-6, thereby implementing a system configuration derivation process that achieves both simplicity as a data representation and the capability of representation for appropriately representing a resource use mode.

The present disclosure provides a system configuration derivation device including: a configuration concretization method capable of concretizing a resource allocation model in a stepwise manner similarly to an abstract configuration; and a resource allocation method for outputting “allocation of the resources to the consumers” from the resource allocation model that has been designed.

### <First Example Embodiment> (Configuration)

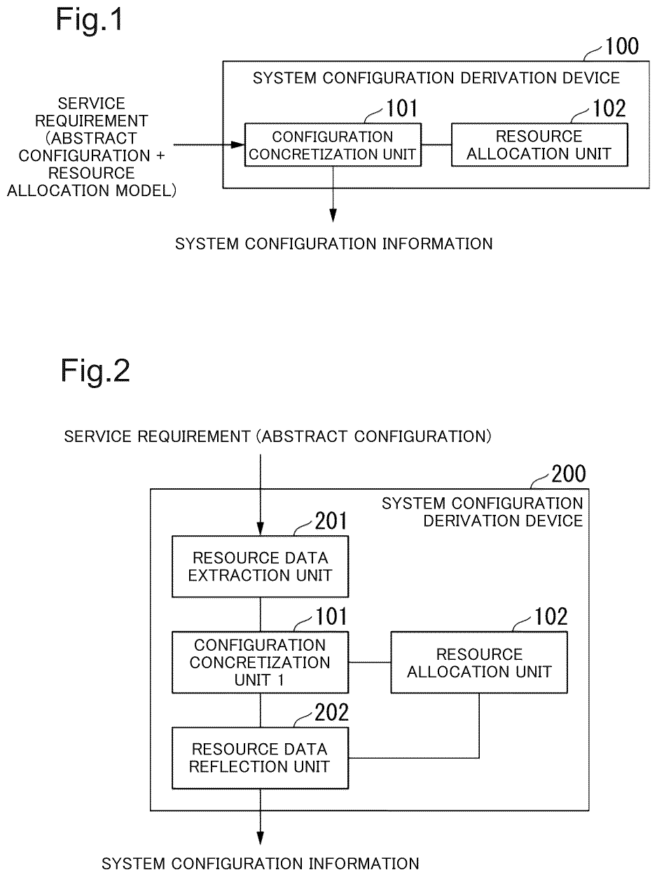

FIG. 1 is a block diagram illustrating a configuration example of a first example embodiment of the system configuration derivation device according to the present disclosure. A system configuration derivation device 100 according to the first example embodiment includes a configuration concretization unit 101 that receives, as input, an abstract configuration that is a part of a system requirement, a resource allocation model that is also a part of the system requirement, and a component model necessary for concretization of the system requirement, and derives a system configuration by concretizing the input abstract configuration and the input resource allocation model in a stepwise manner.

The system configuration derivation device 100 of the first example embodiment includes a resource allocation unit 102 that receives the resource allocation model as input and refines a resource usage status represented by the resource allocation model. When there is no valid resource allocation with respect to the input resource allocation model, the resource allocation unit 102 notifies “allocation impossible” instead of returning the result.

The configuration concretization unit 101 obtains a configuration proposal corresponding to a concrete system configuration by stepwise conversion of data (hereinafter referred to as the “configuration proposal”) in which an abstract configuration is associated with a resource allocation model related to the abstract configuration.

Details of the abstract configuration and the resource allocation model, which are pieces of data treated by the configuration concretization unit 101, will be described hereinafter.

First, the resource allocation model in the present disclosure will be described.

The resource allocation model is data configured by five types of information including sets of physical and/or logical resources that are possible to be included in the system configuration (hereinafter, referred to as “resource groups”), subjects who use the resources (hereinafter, referred to as “consumers”), an inclusion relationship between a resource group and a resource group, disjoint relationship between a resource group and a resource group, and a relationship between a resource group and a consumer (hereinafter, referred to as a “consumption relationship”), and is data representing a constraint condition regarding use of the resources.

Although a case where the resources are memories will be described as an example hereinafter, the “resources” in the present example embodiment are not limited to so-called computer resources such as a CPU and a memory, but correspond to a concept including a system resource, an address, a port, a network band, a license, and the like that need to be occupied for normal operation of constituent elements of a system. For example, in order to operate an “application”, a “host machine” is required. Resources in this case are a CPU, a memory, an HDD, and the like of the host machine. As another example, in order to operate a “front-end application”, a “port (to be listened to for access)” is required, and the port in this case is a resource. In order to operate “access to a service (provided by a certain system) from a user”, a “network band (corresponding to a service load)” is necessary, and the network band in this case is a resource. A “purchased license of Windows (registered trademark)” is necessary to operate the “Windows (registered trademark)” OS, and the purchased license in this case is a resource.

The resource groups of the resource allocation model are objects corresponding to the sets of resources.

The resource group may have detailed information of concrete resources included therein. The resource group not having the detailed information of the concrete resources included therein may also have only information (hereinafter referred to as a “resource capacity”) on a quantity of resources included therein.

The consumers of the resource allocation model are objects each having an identifier for distinguishing between the consumers and a “quantity of required resources (hereinafter referred to as a “required resource amount”)” as attributes. To each of the consumers, it is necessary to allocate resources as many as the required resource amount in such a way as to satisfy a constraint represented by the resource allocation model. However, the same resource cannot be allocated to two or more different consumers.

It is assumed that each of the resource groups and the consumers of the resource allocation model has an identifier for referring to the self.

The inclusion relationship and the disjoint relationship of the resource allocation model are an inclusion relationship and a disjoint relationship in normal meanings as a set of two resource groups. In the present specification, a resource group A including a resource group B is represented as B⊆A, and this relationship indicates that all resources included in the resource group B are included in the resource group A. In the present specification, a disjoint relationship between the resource group A and the resource group B is represented as A≠B, and this relationship indicates that the resource group A and the resource group B do not share the same resource as an element.

The consumption relationship of the resource allocation model is a relationship that “resources included in the resource group A need to be allocated to a consumer p”, and is represented as p→A in the present specification. This relationship represents that the resources included in the resource group A as many as the required resource amount of p are allocated to the consumer p, and does not have information specifying concrete resources to be allocated.

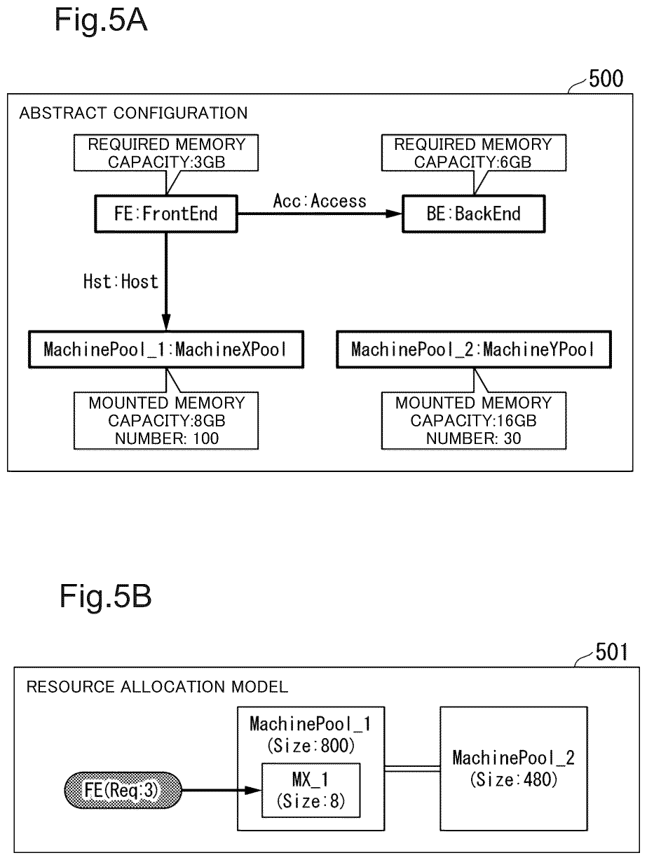

A resource allocation model 501 in FIG. 5B is a specific example of the resource allocation model. Hereinafter, the resource allocation model indicated by this specific example will be described.

A filled rounded square represents a consumer and the resource allocation model 501 includes only one consumer labeled “FE (Req: 3)”. The consumer has “FE” as an identifier, and a required resource amount thereof is 3.

Rectangles represent resource groups, and the resource allocation model 501 includes three resource groups labeled as “MachinePool_1 (Size: 800)”, “MachinePool_2 (Size: 480)”, and “MX_1 (Size: 8)”, respectively. These are the resource groups having “MachinePool_1”, “MachinePool_2”, and “MX_1” as identifiers and having resource capacities of “800”, “480”, and “8”, respectively. Further, for the resource groups “MachinePool_1” and “MachinePool_2”. “memory resources mounted on physical machines X00, X01, . . . , and X99” and “memory resources mounted on physical machines Y00, Y01, . . . , and Y29” are separately and specifically defined as sets of resources, respectively (not illustrated).

An arrow directed from the consumer to the resource group indicates a consumption relationship. The resource allocation model 501 includes the arrow directed from the consumer FE to the resource group MX_1, which indicates that the consumption relationship “FE→MX_1” is included in the resource allocation model.

An inclusion relationship is indicated by representing a certain resource group A in a form of being completely included in another resource group. In the resource allocation model 501, the resource group MX_1 is included in the resource group MachinePool_1, which indicates that the inclusion relationship “MX_1⊆MachinePool_1” is included in the resource allocation model.

A double line connecting a resource group and a resource group indicates a disjoint relationship. In the resource allocation model 501, the resource group MachinePool_1 and the resource group MachinePool_2 are connected by the double line, which indicates that the disjoint relationship “MachinePool_1≠MachinePool_2” is included in the resource allocation model.

The resource allocation model described in the resource allocation model 501 means that MachinePool_1 and MachinePool_2 exist as available calculation resources, and resources of the server MX_1 included in MachinePool_1 are consumed in order to operate an application indicated by FE.

In this example, instead of using a set of machines as a resource group representing calculation resources, the total capacity of memories (random access memories: RAMs) mounted on the machines is considered. Since one resource cannot be allocated to a plurality of consumers in the resource allocation model, if the resource is set to “one machine”, only one application is possible to be hosted on one machine. When a memory mounted on a machine is defined as a resource, applications are possible to be hosted on the same machine as long as a memory capacity is not used up. Although there are resources to be taken into consideration in addition to the memory capacity in actual determination of a host server, here, the memory usage is simply used to simplify a description of an idea.

The above is a description of the resource allocation model in the present disclosure.

Hereinafter, an abstract configuration and a data structure thereof in the present example embodiment will be described. The abstract configuration refers to an abstract system configuration including a portion whose configuration and settings are not yet determined. The abstract configuration plays a role of defining a desired system without specifically referring to details of the system by writing down only determined information, that is, information indicating “any requirements that need to be satisfied by the system and any functions that the system needs to have” by an entity that desires an ICT system.

The abstract configuration is configured based on a graph including a “node” corresponding to a function of a system or a logical or physical component and an “edge” representing a relationship between two nodes by extending between the two nodes. The edge has a direction, and a node n1 and a node n2 are referred to as a “connection source” and a “connection destination”, respectively, when the edge is directed from the node n1 to the node n2. Hereinafter, nodes and edges are collectively referred to as “entities” when being referred to without distinction.

An entity has, as data, an “identifier” for uniquely identifying the entity in the entire system, a “type” representing what kind of concept the entity corresponds to, and a “satisfaction flag” for managing whether an expected configuration has been applied. The identity between entities in two different abstract configurations is determined by identifiers. That is, if the identifiers are the same, they are handled as “the same entity” even if types are different.

An abstract configuration 500 of FIG. 5A is an example of the abstract configuration. Nodes are represented by rectangles describing labels of “(identifier): (type name)”, and edges are represented by arrows with labels of “(identifier): (type name)”. An “entity having an identifier of (identifier) with (type name) as a type” is represented by the label “(identifier): (type name)”. For the entity, a property may be specified by a balloon.

The abstract configuration described in the abstract configuration 500 includes four nodes of FE: FrontEnd, BE: BackEnd, MachinePool_1: MachineXPool, and MachinePool_2: MachineYPool, and two edges of Acc: Access and Hst: Host. Acc is the edge from FE to BE, and Hst is the edge from FE to MachinePool_1.

The nodes FE and BE correspond to a front-end application and a back-end application, respectively. Properties “Required memory capacity: 3 GB” and “Required memory capacity: 6 GB” are specified for FE and BE, respectively, and a “required memory capacity” represents a memory capacity necessary for normal operation.

The nodes MachineXPool and MachineYPool are types that mean sets of physical machine resources of model numbers “MachineX” and “MachineY”, respectively, and MachinePool_1 and MachinePool_2 represent sets of physical machine resources of available model numbers “MachineX” and “MachineY”, respectively. Properties “Mounted memory capacity: 8 GB, Number: 100” and “Mounted memory capacity: 16 GB, Number: 30” are specified in MachinePool_1 and MachinePool_2, respectively. A “mounted memory capacity” represents the capacity of a memory mounted per machine, and the “number” represents the number of servers included in a set of resources.

The edge Acc represents access from the front-end application FE to the back-end application BE. The Access type means that access between applications is possible, but does not include information on how to specifically enable access, and thus needs to be concretized by complementation of a peripheral structure by applying an expected configuration, which will be described later, or representation in a resource allocation model.

The edge Hst indicates that a machine included in MachinePool_1 is used as a hosting server of the front-end application FE. Information on which machine is specifically used is not included in the abstract configuration 500 and is represented by an associated resource allocation model. For example, in a case where the resource allocation model 501 is associated with the abstract configuration 500, a machine corresponding to the resource group MX_1 in the resource allocation model 501 is a host machine.

The above is a description of the abstract configuration 500.

Hereinafter, the “type” of the entity will be described in more detail.

A type of an entity has a role of indicating what type the entity is. There are two types of “abstract type” and “concrete type” as types, and the abstract type indicates an entity of a type that is not intuitively related to a concrete part or connection relationship existing in reality and is required to be further concretized, such as “Machine” or “HTTP connectable”. On the other hand, the concrete type indicates an entity related to a concrete part or connection relationship existing in reality, such as “(concrete machine model number)” or “wired LAN connection”.

In addition, an inheritance relationship may be defined between different types. When a type Ta inherits a type Tb, it means that an entity of the type Ta is possible to also be considered as an entity of the type Tb. For example, a type MachineX, which corresponds to the concrete machine model number, inherits a type PhMachine that represents “all physical machines”. Further, the type PhMachine inherits a type Machine that represents “(all of physical and virtual) machines”. It is assumed that one or a plurality of concrete types inheriting an abstract type exist for all abstract types, and there is no type that inherits a concrete type.

Model data defining information unique to each type is referred to as a “component model” of the type. Although various types of information may be defined in the component model, it is assumed that “property” and “expected configuration” data are included in the present disclosure.

The “property” of the component model is list information of attribute information that is possible to be set to an entity having the type.

The “expected configuration” of the component model is data in which information regarding a peripheral configuration necessary for the entity having the type to normally operate in the system is defined. The configuration concretization unit 101 repeats an operation of compensating for constituent elements and relationships included in the expected configuration to convert a configuration proposal into a concrete system configuration in a stepwise manner.

In the expected configuration of the type, in addition to graph data representing the peripheral configuration necessary for the entity having the type to normally operate in the system, a rule for converting a resource allocation model of the configuration proposal to which the expected configuration is applied is described.

Hereinafter, the expected configuration will be described in detail using an example.

For example, a circumstance that a “physical machine” that hosts an “application” is necessary for operation of the “application” is represented as an expected configuration of an App type corresponding to the “application”.

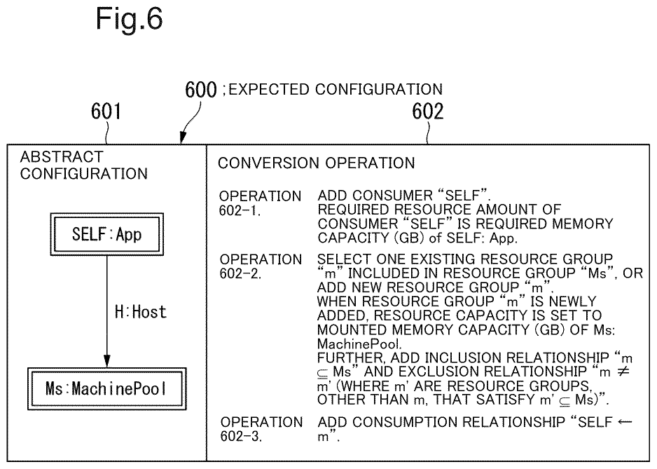

An expected configuration 600 illustrated in FIG. 6 is expected configuration data representing the above-described circumstance.

An abstract configuration 601 is a graph representing a configuration in which an application corresponding to an App type node is hosted by a machine as a peripheral configuration necessary for the App type node to normally operate. An App type node SELF and a MachinePool type node Ms that represents a set of resources including machines are connected by a Host type edge H.

The Host type edge H represents a relationship that “the App type node SELF is hosted by a physical machine resource represented by the node Ms”.

In addition, “SELF” is a special identifier, and each expected configuration represents a structure necessary for an entity of the identifier “SELF” to normally operate. That is, there is exactly one entity of the identifier SELF in all expected configurations. Hereinafter, this “SELF” entity is referred to as a target entity of the expected configuration.

In the expected configuration, some entities including the SELF node are specified as “prerequisite configurations”. The prerequisite configurations are configurations that need to be included in an abstract configuration to be applied in advance during application of the expected configuration (described later). In the drawing of the present specification, the entities included in the prerequisite configurations are drawn by double lines.

For example, in the expected configuration 600 illustrated in FIG. 6, the node SELF and the node Ms are drawn by double lines, which indicates that the prerequisite configurations of the expected configuration are the node SELF and the node Ms.

A conversion operation 602 is data defining three change operations (conversion operations 602-1, 602-2, and 602-3) to be performed on the resource allocation model of the configuration proposal to which the expected configuration is applied in order to represent various constraints on resources consumed by the App type node SELF.

The conversion operation 602-1 is an operation of newly generating a consumer “SELF” who consumes resources of a resource group “MXs”. Since the consumer “SELF” is related to the App type node “SELF”, a required resource amount is set to a value equal to a required memory capacity set in the App type node “SELF”.

The conversion operation 602-2 is an operation of cutting out, as a resource group “m”, a resource group for one machine from the resource group “MXs”. At this time, (1) what is already included in the resource group “Ms” is selected as the resource group “m”, or (2) the resource group “m” is newly generated and an inclusion relationship “m⊆Ms” and a disjoint relationship “m≠m′ (m′ are all resource groups, other than m, that satisfy m′⊆(MXs)” are added. Whether to newly add the resource group is possible to be freely selected, and when the resource group “m” is newly added, a resource capacity thereof is set to a value equal to a mounted memory capacity set in the MachinePool type node Ms.

The conversion operation 602-3 adds a consumption relationship “SELF→m” between the consumer “SELF” and the resource group “m”.

The above is a description of the expected configuration 600.

Two or more expected configurations may be set for one type. In such a case, if any one of the plurality of expected configurations is applied, it means that an entity of the type normally operates.

Further, there is a type for which no expected configuration is specified, and this means that an entity of the type does not require a dependent part but normally operates as a system component alone.

The above is the description regarding the “expected configuration” of the type.

Next, the “satisfaction flag” of the entity will be described.

An entity of a type T is associated with a set of flags having all ancestor types T(1), T(2), . . . , and T(m) of the type T and the type T itself as keys. This is referred to as satisfaction flags of the entity. Each of the flags is assigned a value of TRUE or FALSE.

When all the satisfaction flags are TRUE, it is said that the satisfaction flags are satisfied, and when there is one being FALSE, it is said that the satisfaction flags are insufficient. In particular, when a flag for a type T(i) is FALSE, an entity thereof is said to be insufficient for the type T(i). As will be explained later, an expected configuration of the type T(i) is possible to be applied to the entity that is insufficient for the type T(i), and the flag becomes TRUE simultaneously with the application.

Note that it is assumed that an entity originally included in an abstract configuration or an entity newly generated by applying an expected configuration (described later) is given satisfaction flags using a type of the entity and its ancestor types as keys, and an initial value of each of the flags is FALSE when the expected configuration exists in the type used as the key, and is TRUE otherwise.

The above is the description regarding the “satisfaction flag” of the entity.

Next, concretization of a configuration proposal will be described. Two kinds of concretization operations of “applying an expected configuration” and “type refinement” is possible to be performed on a configuration proposal, and one or a plurality of configuration proposals is possible to be newly obtained as a result of any of the operations.

First, “applying an expected configuration” to a configuration proposal D is performed according to the following steps.
1. An entity e that is included in an abstract configuration of D and has an insufficient satisfaction flag is selected.
2. The type T for which the entity e is insufficient is selected.
3. For each expected configuration EX of the type T in which a prerequisite configuration is included in the abstract configuration of D, a result of performing the following operation on the abstract configuration of D is output as a result of the operation of “applying an expected configuration”:
“A necessary entity is added to the abstract configuration of D in such a way that the abstract configuration of the expected configuration EX appears in a form in which the entity e matches with SELF, and the resource allocation model of D is rewritten in accordance with a rewriting rule of the resource allocation model defined in the expected configuration. Thereafter, the satisfaction flag regarding the type T of the entity e is updated to TRUE”.

The above is the description regarding the application of the expected configuration.

However, there may be a plurality of methods for executing the conversion in step 3 per expected configuration. Hereinafter, such a case will be described using specific examples.

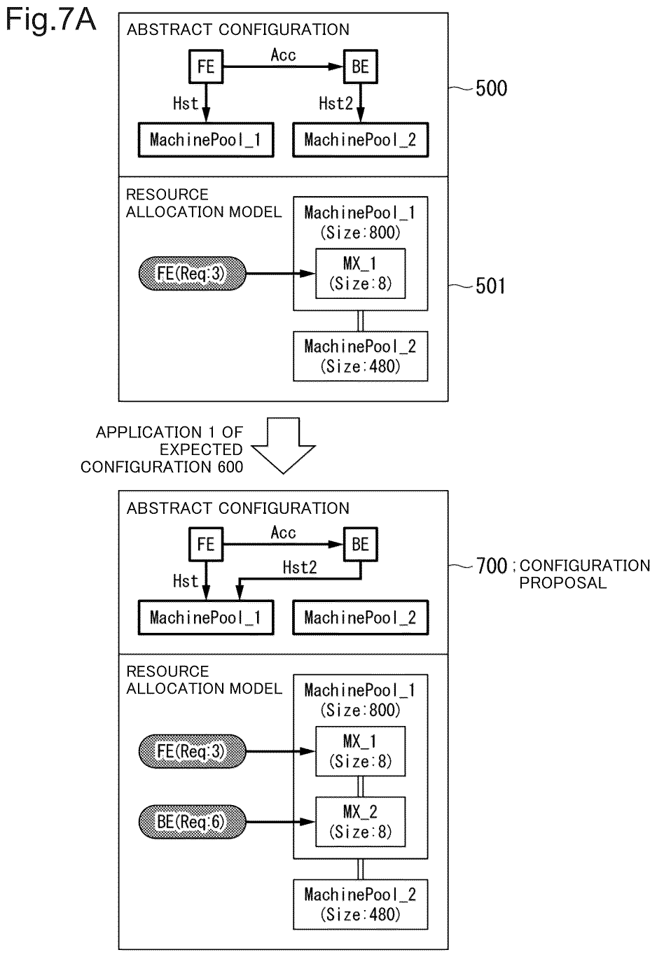

FIGS. 7A to 7C are diagrams for describing examples of concretizing the configuration proposal illustrated in FIG. 5A by three different methods according to the expected configuration illustrated in FIG. 6.

In this example, it is assumed that the FrontEnd type and the BackEnd type each inherit the App type, and the MachineXPool type and the MachineYPool type each inherit the MachinePool type.

Three configuration proposals 700, 701, and 702 are all configuration proposals obtained as a result of applying the expected configuration 600 to the node BE in the abstract configuration 500, but host machines of the BE thereof are different.

The configuration proposal 700 of FIG. 7A is a case where a machine with a model number “MachineX” is used as a hosting server of the node BE, but the machine is different from a hosting server of the node FE. The configuration proposal 700 is possible to be concretized by selecting the node MachinePool_1 of the abstract configuration 500 as a node corresponding to the node Ms in FIG. 6 and then newly generating a resource group “MX_2” as the resource group “m” in the conversion operation 602-2.

The configuration proposal 701 of FIG. 7B is a case where a machine with the same model number “MachineX” as a hosting server of the node FE is used as a hosting server of the node BE. The configuration proposal 701 is possible to be concretized by selecting the node MachinePool_1 of the abstract configuration 500 as a node corresponding to the node Ms in FIG. 6 and then selecting the existing resource group “MX_1” as the resource group “m” in the conversion operation 602-2.

The configuration proposal 702 of FIG. 7C is a case where a machine with a model number “MachineY” is used as a hosting server of the node BE. The configuration proposal 702 is possible to be concretized by selecting the node MachinePool_2 of the abstract configuration 500 as a node corresponding to the node Ms in FIG. 6 and then newly generating a resource group “MY_1” as the resource group “m” in the conversion operation 602-2.

As described above, in a case where there are a plurality of methods for causing an abstract configuration of an expected configuration to appear in an abstract configuration as an application target, or in a case where there is a branch in the operation of the resource allocation model, a plurality of kinds of concretization is possible to be achieved from application of a single expected configuration.

The above is the description regarding the application of the expected configuration using the specific examples.

Second, the “type refinement” operation for the configuration proposal D is performed according to the following steps.
1. The entity e that has an abstract type and is included in the abstract configuration of D is selected.
2. For all types T′ that inherit the type T of the entity e, a result of performing the following operation on the abstract configuration of D is output as a result of the “type refinement” operation:
“The type of the entity e is changed to T′, and a flag using T′ as a key is added to the satisfaction flag. However, a value of the flag of T′ is FALSE when one or more expected configurations are present in T′, and is TRUE when there is no expected configuration”.

The above is the description regarding the concretization of the configuration proposal.

Next, a definition of a “concrete configuration proposal” obtained as a result of concretizing the configuration proposal will be described.

The concrete configuration proposal in the present disclosure refers to a configuration proposal including a completely concretized abstract configuration. Here, the abstract configuration being “completely concretized” means that all of the following three types of concretization conditions (Concretization Condition 1), (Concretization Condition 2), and (Concretization Condition 3) are satisfied.
(Concretization Condition 1) The abstract configuration does not include any node having an abstract type.
(Concretization Condition 2) The abstract configuration does not include any edge having an abstract type.
(Concretization Condition 3) The abstract configuration does not include any entity having an insufficient satisfaction flag.

From definitions of the concretization conditions, it is possible to be said that the abstract configuration not including a unit requirement indicates a state in which there is no ambiguous portion as the ICT system and all parts necessary for the operation (expected configurations for the respective entities) are arranged.

Next, the “resource usage status” which is data representing a specific form of resource allocation represented by the resource allocation model will be described.

The “resource usage status (valid for the resource allocation model)” refers to dictionary data Rs representing allocation of sets of concrete resources with respect to all consumers or resource groups included in the resource allocation model, the dictionary data Rs satisfying all of the following conditions (1) to (6).
(1) A quantity of resources Rs[c] allocated to a consumer c is equal to a required resource amount of the consumer c.
(2) A quantity of resources Rs[R] allocated to a resource group R whose resource capacity is defined is equal to a resource capacity defined in the resource group R.
(3) For any different two consumers c1 and c2, allocated resources Rs[c1] and Rs[c2] do not overlap.
(4) For any two resource groups R1 and R2 (R1≠R2) having a disjoint relationship, allocated resources Rs[R1] and Rs[R2] do not overlap.
(5) For all the two resource groups R1 and R2 (R1⊆R2) having an inclusion relationship, allocated resources satisfy an inclusion relationship Rs[R1]⊆Rs[R2].
(6) If the consumer c and the resource group R are in a consumption relationship c→R, allocated resources satisfy an inclusion relationship Rs[c]⊆Rs[R].

The resource allocation model represents a constraint condition related to the resource used by the consumer, whereas the resource usage status represents a concrete resource allocation method satisfying the constraint condition.

The concretized abstract configuration and the resource usage status correspond to a configuration of a fully operating system and the allocation of resources, respectively.

Therefore, the system configuration derivation device 100 outputs a set of the concretized abstract configuration and the allocation of resources as information representing the system configuration.

### (Operation)

The system configuration derivation device 100 receives, as input, a system requirement including an abstract configuration and a resource allocation model, and outputs a concretized abstract configuration and a resource usage status that satisfy the system requirement.

Hereinafter, processing of each unit of the system configuration derivation device 100 will be described in detail.

First, operation of concretizing a configuration proposal by the configuration concretization unit 101 of the first example embodiment will be described.

The configuration concretization unit 101 of the first example embodiment is basically the same as a configuration concretization procedure described in JP 6989014 B1, but is different in terms of including a step of receiving the resource allocation model as input in addition to the abstract configuration, verifying the resource allocation model in the middle of concretization performed by the resource allocation unit 102, and removing a configuration proposal that requires invalid resource allocation.

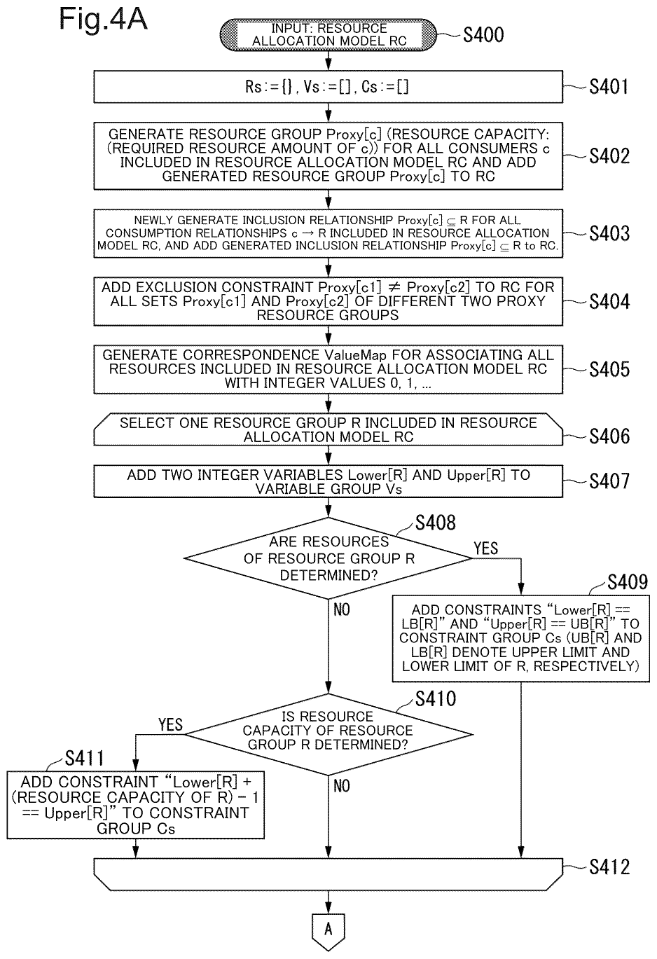

FIG. 3 is a flowchart illustrating a procedure in which the configuration concretization unit 101 of the first example embodiment derives the concretized abstract configuration and the resource usage status for the system requirement.

The configuration concretization unit 101 receives, as input, a configuration proposal D_init corresponding to a system requirement from an input/output device (step S300). The configuration proposal D_init includes an abstract configuration and a resource allocation model related to the abstract configuration.

The configuration concretization unit 101 initializes a search candidate list T with an empty list (step S301).

The configuration concretization unit 101 initializes a searched configuration proposal list V with an empty list (step S302).

The configuration concretization unit 101 adds D_init to T and V (step S303).

The configuration concretization unit 101 proceeds to step S305 if the search candidate list T includes a configuration proposal and T does not include a concrete configuration proposal, and proceeds to step S314 otherwise. (Step S304)

The configuration concretization unit 101 selects one configuration proposal D included in T (step S305).

The configuration concretization unit 101 generates configuration proposals D_1, D_2, . . . , and D_N obtained by concretizing the configuration proposal D selected in step S305 (step S306).

The configuration concretization unit 101 executes the procedure from step S308 to step S311 on each configuration proposal D_i generated in the previous step (step S307).

The configuration concretization unit 101 returns to step S307 if D_i is included in the searched configuration proposal list V, and proceeds to step S309 otherwise (step S308).

The configuration concretization unit 101 inputs a resource allocation model of D_i to the resource allocation unit 102 and verifies the output. When “allocation impossible” is notified, the configuration concretization unit 101 returns to step S307. When allocation of resources is output, the configuration concretization unit 101 proceeds to step S311 (step S310).

The configuration concretization unit 101 adds the configuration proposal D_i to T (step S311).

The configuration concretization unit 101 executes the procedure from step S308 to step S311 on all the configuration proposals D_i generated in step S306, and then returns to step S304 (step S312).

The configuration concretization unit 101 inputs a resource allocation model of a concrete configuration proposal D_out included in the search candidate list T to the resource allocation unit 102, and obtains a resource usage status Rs as output. If it is impossible for the search candidate list T to include a concrete configuration proposal, a search failure is notified (step S313).

The configuration concretization unit 101 outputs a set of the abstract configuration of the concrete configuration proposal D_out and the resource usage status Rs to the input/output device as a result of the system configuration derivation device 100 (step S314).

The above is the description of the operation of the configuration concretization unit 101.

Next, operation of the resource allocation unit 102 will be described. The resource allocation unit 102 of the first example embodiment receives a resource allocation model as input and returns an appropriate resource usage status.

The resource allocation unit 102 of the present example embodiment represents various relationships included in the resource allocation model as a linear constraint problem on integer variables, and finds allocation to the variables satisfying the linear constraint problem, thereby determining a final resource usage status. Note that the linear constraint problem on integer variables is a problem in which a variable group X[1], X[2], . . . , and X[n] to which an integer is possible to be allocated and linear constraints related thereto, that is, an equality or an inequality (for example, “X[1]==X[2]+X[4]”, “5*X[1]≤3*X[3]+4”, and the like) that does not include multiplication between variables are defined, and allocation of values to variables that satisfy all the constraints is a solution to the problem.

Hereinafter, the operation of the resource allocation unit 102 in step S313 will be described in detail.

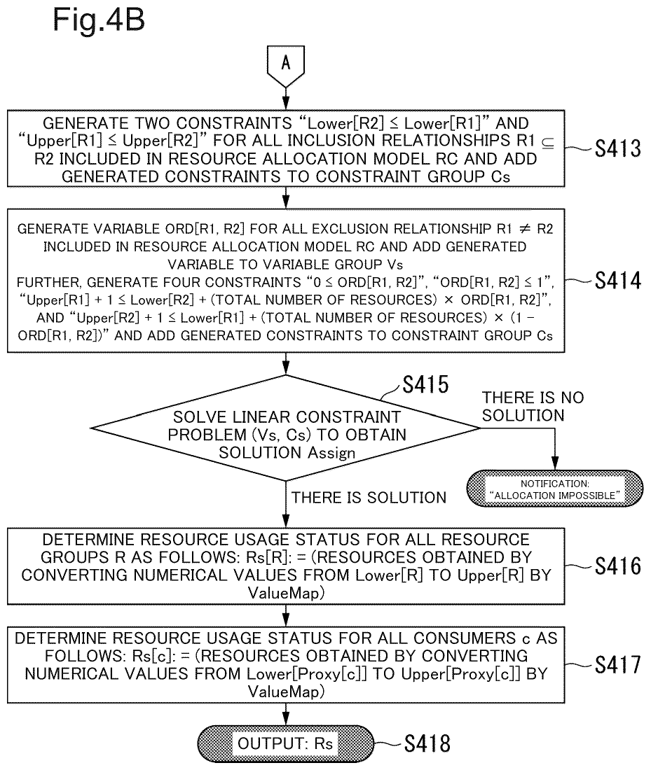

FIGS. 4A and 4B are flowcharts illustrating the entire operation of the resource allocation unit 102.

The resource allocation unit 102 receives a resource allocation model RC as input (step S400).

The resource allocation unit 102 initializes the resource usage status Rs with an empty dictionary. A variable group Vs and a constraint group Cs are initialized with empty lists (step S401).

The resource allocation unit 102 newly adds resource groups Proxy[c] to RC for all the consumers c included in the resource allocation model RC, and sets a resource capacity to a required resource amount of each of the consumers c (step S402).

In the following description, Proxy[c] is referred to as a “proxy resource group” for the consumer c.

The resource allocation unit 102 newly adds inclusion relationships Proxy[c]⊆R to RC for all the consumption relationships c→R included in the resource allocation model RC (step S403).

The resource allocation unit 102 adds exclusion constraints Proxy[c1]≠Proxy[c2] to RC for all sets Proxy[c1] and Proxy[c2] of two different proxy resource groups (step S404).

The resource allocation unit 102 determines a one-to-one correspondence ValueMap in which all resources included in the resource allocation model RC are associated with integer values of 0, 1, . . . , and so on (the total number of resources).

At this time, the resource group R in which a set of included resources is determined is associated with one section. That is, when a set of all the resources included in the resource group R is converted by the ValueMap, a set {LB[R], LB[R]+1, . . . , UB[R]−1, and UB[R]} is obtained. Integers LB[R] and UB[R] are referred to as a lower limit and an upper limit of the resource group R (step S405).

The resource allocation unit 102 executes the procedure of steps S407 to S411 for all the resource groups R included in the resource allocation model RC (step S406).

The resource allocation unit 102 adds two integer variables Lower[R] and Upper[R] to the variable group Vs (step S407).

The resource allocation unit 102 executes step S409 when a set of resources included in the resource group R has been determined, and executes step S410 otherwise (step S408).

The resource allocation unit 102 adds constraints “Lower[R]==LB[R]” and “Upper[R]==UB[R]” to the constraint group Cs and executes step S412 (step S409).

The resource allocation unit 102 executes step S411 when a resource capacity of the resource group R has been determined, and executes step S412 otherwise (step S410).

The resource allocation unit 102 adds a constraint “Lower[R]+(resource capacity of R)−1==Upper[R]” to the constraint group Cs and executes step S412 (step S411).

The resource allocation unit 102 generates two constraints “Lower[R2]≤Lower[R1]” and “Upper[R1]≤Upper[R2]” for all inclusion relationships R1⊆R2 included in the resource allocation model RC, and adds the generated constraints to the constraint group Cs (step S413).

The resource allocation unit 102 generates a variable ORD[R1, R2] for all disjoint relationships R1≠R2 included in the resource allocation model RC and adds the generated variable to the variable group Vs. Further, four constraints “0≤ORD[R1, R2]”, “ORD[R1, R2]≤1”, “Upper[R1]+1≤Lower[R2]+(the total number of resources)×ORD[R1, R2]”, and “Upper[R2]+1≤Lower[R1]+(the total number of resources)×(1−ORD[R1, R2])” are generated and added to the constraint group Cs (step S414).

The four constraints added in step S414 are essentially the same as “Upper[R1]+1≤Lower[R2] or Upper[R2]+1≤Lower[R1]”. This takes a form of a disjunctive constraint (=a constraint in a format that one of two constraints is satisfied) since it is not clear which of R1 and R2 in the disjoint relationship includes a resource with a “lower” number.

Since the disjunctive constraint often takes time to resolve, the order between a resource group (RL) with a lower number and the other resource group (RU) is determined only when which one of R1 and R2 in the disjoint relationship includes a resource with a lower number is possible to be identified or is possible to be assumed without loss of generality, and only one constraint “Upper[RL]+1≤Lower[RU]” may be added instead of the four constraints.

The resource allocation unit 102 obtains a solution Assign to the linear constraint problem defined by the constraint group Cs on the variable group Vs (Assign is a correspondence from a variable to an integer value). However, in a case where there is no solution, “allocation impossible” is notified, and the processing ends (step S415).

Note that a method for solving the linear constraint problem executed by the resource allocation unit 102 in step S415 is not particularly limited, and a known method may be used. Specifically, a method, such as a branch-and-bound method of obtaining a solution to an original problem by repeatedly solving a simpler problem (relaxed problem) obtained by relaxing a variable from an integer to a real number, a cutting plane method of obtaining an integer solution by solving a problem to which a constraint is added in such a way that a solution is an integer after solving a relaxed problem, or a branch-and-cut method of implementing a faster solution by combining the above two methods, is well known and is possible to be employed as the solving method in the resource allocation unit 102.

The resource allocation unit 102 determines allocation of Rs[R]=(resources obtained by converting numerical values from Lower[R] to Upper[R] by ValueMap) for all the resource groups R (step S416).

The resource allocation unit 102 determines allocation of Rs[c]=(resources obtained by converting numerical values from Lower[Proxy[c]] to Upper[Proxy[c]] by ValueMap) for all the consumers c (step S417).

The resource allocation unit 102 outputs the obtained allocation Rs (step S418).

The above is the description of the operation of the resource allocation unit 102 of the present example embodiment.

Next, a specific example of the operation of the resource allocation unit 102 will be described.

First, operation when the resource allocation model of the configuration proposal 700 in FIG. 7A is input to the resource allocation unit 102 will be described.

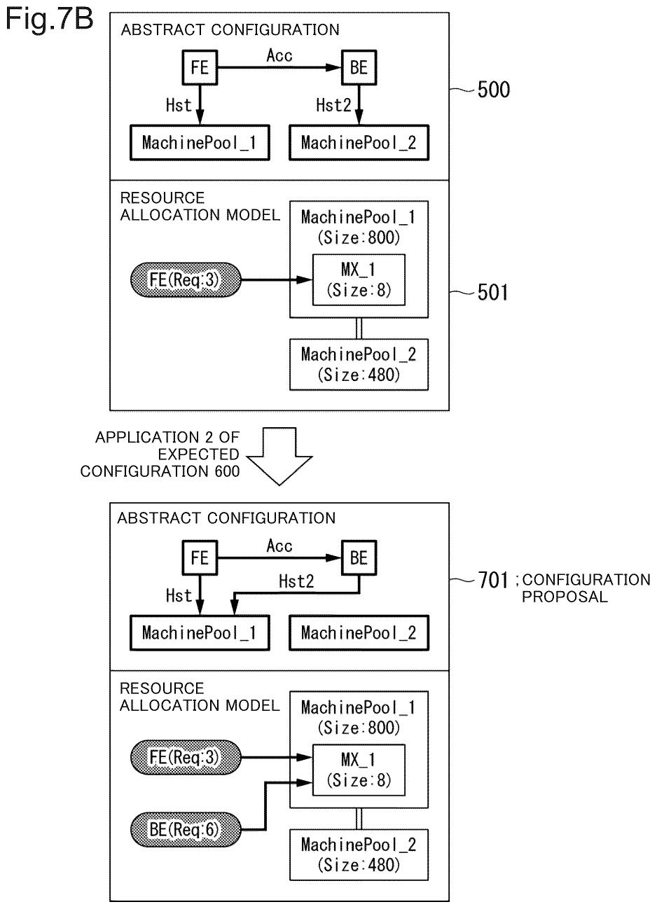

A resource allocation model 800 of FIG. 8A illustrates the resource allocation model of the configuration proposal 700 to which the proxy resource groups and the constraint related to the proxy resource groups are added in steps S402 to S404.

In the correspondence ValueMap between resources included in the resource groups MachinePool_1 and MachinePool_2 and integers calculated in step S405, 800 resources included in MachinePool_1 are associated with integer values 0, 1, . . . , and 799, and 480 resources included in MachinePool_2 are associated with integer values 800, 801, . . . , and 1279.

Upper limits of the resource groups MachinePool_1 and MachinePool_2 are UB[MachinePool_1]=799 and UB[MachinePool_2]=1279, respectively, and lower limits thereof are LB[MachinePool_1]=0 and LB[MachinePool_2]=800, respectively.

In addition to what has been described above, ValueMap for the resource groups MachinePool_1 and MachinePool_2 includes one in which 480 resources included in MachinePool_2 are associated with integer values 0, 1, . . . , and 479, and 800 resources included in MachinePool_1 are associated with integer values 480,481, . . . , and 1279.

Based on the resource allocation model 800, a linear constraint generated and added in each step of steps S409, S411, S413, and S414 is as follows.

$$( Step S 409 ) \cdot Upper [ MachinePool\_ 1 ] == UB [ MachinePoo1\_ 1 ] \cdot Upper [ MachinePool\_ 2 ] == UB [ MachinePool\_ 2 ] \cdot Lower [ MachinePool\_ 1 ] == LB [ MachinePoo1\_ 1 ] \cdot Lower [ MachinePool\_ 2 ] == LB [ MachinePoo1\_ 2 ]$$

$$( Step S 4 \; 11 ) = Lower [ MX\_ 1 ] + 7 == Upper [ MX\_ 1 ] \cdot Lower [ MX\_ 2 ] + 7 == Upper [ MX\_ 2 ] \cdot Lower [ Proxy [ FE ] ] + 2 == Upper [ Proxy [ FE ] ] \cdot Lower [ Proxy [ BE ] ] + 5 == Upper [ Proxy [ BE ] ]$$

$$( Step S 413 ) \cdot Lower [ MachinePool\_ 1 ] \leq Lower [ MX\_ 1 ] \cdot Upper [ MX\_ 1 ] \leq Upper [ MachinePool\_ 1 ] \cdot Lower [ MX\_ 2 ] \cdot Upper [ MX\_ 2 ] \leq Upper [ MachinePool\_ 1 ] \cdot Lower [ MX\_ 1 ] \cdot Lower [ MX\_ 1 ] \leq Lower [ Proxy [ FE ] ] \cdot Upper [ Proxy [ FE ] ] ] \cdot Upper [ Lower [ MX\_ 1 ] \cdot Lower [ MX\_ 2 ] \leq Lower [ Proxy [ BE ] ] ] \cdot Upper [ Proxy [ BE ] ] ] \leq Upper [ MX\_ 2 ]$$

$$( Step S 414 ) \cdot 0 \leq ORD [ MachinePool\_ 1 , MachinePool\_ 2 ] \cdot ORD [ MachinePool\_ 1 , MachinePool\_ 2 ) \leq 1 \cdot Upper [ MachinePool\_ 1 ] + 1 \leq Lower [ MachinePool\_ 2 ] + 1280 \times ORD [ MachinePool\_ 1 , MachinePool\_ 2 ] \cdot Upper [ MachinePool\_ 1 ] + 1 \leq Lower [ MachinePool\_ 2 ] + 1280 \times ( 1 - ORD [ MachinePool\_ 1 , MachinePool\_ 2 ] ) \cdot 0 \leq ORD [ MX\_ 1 , MX\_ 2 ] \cdot ORD [ MX\_ 1 , MX\_ 2 ] \leq 1 \cdot Upper [ MX\_ 1 ] + 1 \leq Lower [ MX\_ 2 ] + 1280 \times ORD [ MX\_ 1 , MX\_ 2 ] \cdot Upper [ MX\_ 1 ] + 1 \leq Lower [ MX\_ 2 ] + 1280 \times ( 1 - ORD [ MX\_ 1 , MX\_ 2 ] ) \cdot 0 \leq ORD [ Proxy [ FE ] , Proxy [ BE ] ] \cdot ORD [ Proxy [ FE ] , Proxy [ BE ] ] \leq 1 \cdot Upper [ Proxy [ FE ] ] + 1 \leq Lower [ Proxy [ BE ] ] + 1280 \times ORD [ Proxy [ FE ] , Proxy [ BE ] ] \cdot Upper [ Proxy [ FE ] ] + 1 \leq Lower [ Proxy [ [ BE ] ] + 1280 \times ( 1 - ORD [ Proxy [ FE ] , Proxy [ BE ] ] )$$

By step S415, an example of the solution Assign of the linear constraint problem including the above constraints is as follows.

Assign: Lower[MachinePool_1]: 0Upper[MachinePool_1]: 799Lower[MachinePool_2]: 800Upper[MachinePool_2]: 1279Lower[MX_1]: 0Upper[MX_1]: 7Lower[MX_2]: 8Upper[MX_2]: 15Lower[Proxy[FE]]: 0Upper[Proxy[FE]]: 2Lower[Proxy[BE]]: 8Upper[Proxy[BE]]: 13ORD[MachinePool_1, MachinePool_2]: 0ORD[MX_1, MX_2]: 0ORD[Proxy[FE], Proxy[BE]]: 0

As a result, a resource usage status obtained by inputting the configuration proposal 700 to the resource allocation unit 102 is as follows. However, allocated resources are indicated by assigned numbers based on ValueMap.

MachinePool_1: {0, 1, . . . , 799} MachinePool_2: {800, 801, . . . , 1279} MX_1: {0, 1, 2, 3, 4, 5, 6, 7} MX_2: {8, 9, 10, 11, 12, 13, 14, 15} FE:{0, 1, 2} BE:{8, 9, 10, 11, 12, 13}

The above is the description of the operation when the resource allocation model of the configuration proposal 700 in FIG. 7A is input to the resource allocation unit 102.

Next, the operation when the resource allocation model of the configuration proposal 701 in FIG. 7B is input to the resource allocation unit 102 will be described.

A resource allocation model 801 of FIG. 8B illustrates the resource allocation model of the configuration proposal 701 to which the proxy resource groups and the constraints related to the proxy resource groups are added in steps S402 to S404.

Although ValueMap and the like are exactly the same as those in the case of the configuration proposal 700, in a case where a linear constraint condition is generated from the resource allocation model of the configuration proposal 701, the result includes the following constraints (1) to (11).

$$Lower [ MX\_ 1 ] + 7 = Upper [ MX\_ 1 ] \qquad ( 1 )$$

$$Lower [ Proxy [ FE ] ] + 2 == Upper [ Proxy [ FE ] ] \qquad ( 2 )$$

$$Lower [ Proxy [ BE ] ] + 5 == Upper [ Proxy [ BE ] ] \qquad ( 3 )$$

$$Lower [ MX\_ 1 ] \leq Lower [ Proxy [ FE ] ] \qquad ( 4 )$$

$$Lower [ MX\_ 1 ] \leq Lower [ Proxy [ BE ] ] \qquad ( 5 )$$

$$Upper [ Proxy [ FE ] ] \leq Upper [ MX\_ 1 ] \qquad ( 6 )$$

$$Upper [ Proxy [ BE ] ] \leq Upper [ MX\_ 1 ] \qquad ( 7 )$$

$$0 \leq ORD [ Proxy [ FE ] , Proxy [ BE ] ] \qquad ( 8 )$$

$$ORD [ Proxy [ FE ] , Proxy [ BE ] ] \leq 1 \qquad ( 9 )$$

$$Upper [ Proxy [ FE ] ] + 1 \leq Lower [ Proxy [ BE ] ] + 1280 \times ORD [ Proxy [ FE ] , Proxy [ BE ] ] \qquad ( 10 )$$

$$Upper [ Proxy [ FE ] ] + 1 \leq Lower [ Proxy [ BE ] ] + 1280 \times ( 1 - ORD [ Proxy [ FE ] , Proxy [ BE ] ] ) \qquad ( 11 )$$

In fact, it is possible to be seen that there is no allocation of values to variables satisfying all of these. This will be described below.

First, although ORD[Proxy[FE], Proxy[BE]] takes a value of 0 or 1, it is possible to be explained that there is no allocation for the same reason in both cases, and thus, the case of ORD[Proxy[FE], Proxy[BE]]=0 will be considered hereinafter.

At this time, the constraint (11) is satisfied for any allocation, and thus is possible to be ignored. It is possible to be seen that Proxy[FE] includes a resource with a “lower” number than Proxy[BE] from the constraint (10).

Then, since “a value of Upper[Proxy[FE]] is exactly larger than a value of Lower[Proxy[FE]] by 2 (from the constraint (2))”, “a value of Lower[Proxy[BE]] is larger than the value of Upper[Proxy[FE]] by 1 or more (from the constraint (11))”, and “a value of Upper[Proxy[BE]] is exactly larger than the value of Lower[Proxy[BE]] by 5 (from the constraint (3))”, it is possible to be seen that “the value of Upper[Proxy[BE]] is larger than the value of Lower[Proxy[FE]] by 8 or more”, and it is possible to be seen that the magnitude of an integer value section Lower[Proxy[FE]] to Upper[Proxy[BE]] should be 9 or more.

However, the section Lower[Proxy[FE]] to Upper[Proxy[BE]] is included in a section Lower[MX_1] to Upper[MX_1] from the constraints (4) and (7), and the magnitude of the latter section from the constraint (1) is exactly 8. Therefore, it is possible to be seen that there is no allocation of integer values to variables that simultaneously satisfy these constraints.

From the above, when the resource allocation model of the configuration proposal 701 in FIG. 7B is input to the resource allocation unit 102, “allocation impossible” is notified in S415.

The above is the description regarding the specific example of the operation of the resource allocation unit 102 of the present example embodiment.

Note that, as described above, an appropriate resource usage status with respect to the resource allocation model exists for the configuration proposal 700 of FIG. 7A, but does not exist for the configuration proposal 701 of FIG. 7B. Therefore, in a case where the configuration concretization unit 101 attempts concretization with respect to FIG. 5A and FIG. 5B in the middle of a search, in step S310, the resource usage status is found for the configuration proposal 700 and thus is added to configuration proposal candidates T, but there is no addition to the configuration proposal candidates T for the configuration proposal 701 since “allocation impossible” is notified.

### Effects

The configuration concretization unit 101 of the present example embodiment is possible to efficiently implement concretization using resources by treating a large amount of resources as a set instead of individual nodes.

For example, considering a case where the resource capacity of each of MachinePool_1 and MachinePool_2 has increased by a factor of 10,000 in the example illustrated in FIGS. 7A to 7C, if the resources are individually represented as the nodes without using the resource allocation model, each of a data size and the number of branches increases by a factor of 10,000. On the other hand, when the resources are treated as the set by the configuration concretization unit 101 of the present example embodiment, a size of data representing a configuration proposal does not change, and the number of configuration proposals appearing as a result of the concretization also does not change from 3.

Further, the resource allocation unit 102 according to the present example embodiment is possible to refine a concrete usage status of the resources from the resource allocation model. As a result, it is possible to concretize the connection between the resource and the consumer, partially abstracted at the time of output from the configuration concretization unit 101 of the present example embodiment, and complement information necessary for designing a system configuration.

Therefore, the system configuration derivation device 100 of the present example embodiment is possible to efficiently find a system configuration satisfying a service requirement specifying a large amount of available resources with a calculation amount substantially independent of the amount of resources.

### Second Example Embodiment

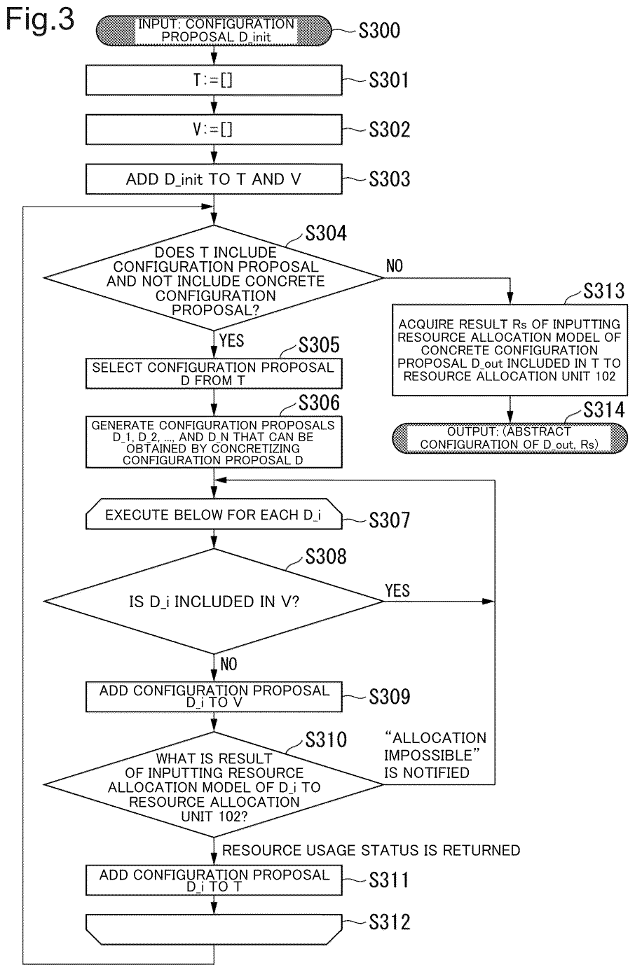

Next, a second example embodiment of the present disclosure is described. FIG. 2 is a block diagram illustrating a configuration example of a system configuration derivation device according to the second example embodiment.

A system configuration derivation device 200 includes the same constituent elements as those of the system configuration derivation device 100 of the first example embodiment, but a resource data extraction unit 201 is added as an input device, and a resource data reflection unit 202 is added as an output device.

The system configuration derivation device 200 includes the resource data extraction unit 201 that receives an abstract configuration as input and divides the abstract configuration into two of an abstract configuration in which a resource portion is abstracted and a resource allocation model by representing a resource group included in the abstract configuration by the resource allocation model.

The system configuration derivation device 200 includes the resource data reflection unit 202 that receives a set of the abstract configuration and a resource usage status as input and reflects the resource usage status in the abstract configuration for conversion into an abstract configuration in which each of a “resource” and “resource usage” is individually concretized as an entity or a property.

In the system configuration derivation device 200, the resource allocation model is not explicitly specified from a user, which is different from the first example embodiment. Therefore, it is necessary to define, in type information, a conversion rule (hereinafter referred to as a “resource conversion rule”) from the “abstract configuration” to a “configuration proposal including the resource allocation model” and a conversion rule (hereinafter referred to as a “configuration conversion rule”) from the “configuration proposal including the resource allocation model” and the “resource usage status” to the “abstract configuration”.

Hereinafter, examples of the “resource conversion rule” and the “configuration conversion rule” will be described in detail.

A resource conversion rule “Convert-XResource” for replacing a “MachineX” type node with a “MachineXPool” type node and adding the resource allocation model is a conversion rule defined by the following conversion steps (1) to (5).
(1) A resource group pool_mx is added to the resource allocation model. Resources included in pool_mx are numerical values 1, 2, 3, . . . (Number of MachineX type nodes included in abstract configuration×8).
(2) An operation of adding a consumer a and a resource group m to the resource allocation model is performed for all “Host type edges extended from App type nodes a to MachineX type nodes m” included in the abstract configuration (at this time, if the resource group m already exists in the resource allocation model, the addition operation is skipped).
A required resource amount of a is set to a required memory capacity of the node a, and a resource capacity of m is set to 8. Further, an inclusion relationship m⊆pool_mx and a consumption relationship a→m are added to the resource allocation model.
(3) A disjoint relationship m1≠m2 between two different resource groups m1 and m2 included in pool_mx is added to the resource allocation model.
(4) A “MachineXPool” type node pool_mx is added to the abstract configuration, and all end points of “Host type edges from App type nodes to MachineX type nodes” are changed to pool_mx.
(5) Remove all the MachineX type nodes from the abstract configuration.

A configuration conversion rule “Invert-XResource” that reflects a resource usage status Rs with respect to the abstract configuration of a configuration proposal concretized based on a requirement to which the resource allocation model has been added by the resource conversion rule “Convert-XResource” is a conversion rule defined by the following conversion rules (1) and (2).
(1) With reference to the resource usage status Rs[a] for the consumer a included in the resource allocation model, if there is a resource group mx, which is not pool_mx and includes the resource, the MachineX type node mx is added to the abstract configuration (which is skipped if a node with the same name already exists). Thereafter, the end points of the Host type edges from the nodes a included in the abstract configuration to the node pool_mx are changed to mx.
(2) The node pool_mx is deleted from the abstract configuration.

The above is the specific examples of the resource conversion rule and the configuration conversion rule.

Note that the resource conversion rule and the configuration conversion rule used in the second example embodiment of the present disclosure are not limited to those described above, and a plurality of resource conversion rules and a plurality of configuration conversion rules are possible to be used.

### (Operation)

The system configuration derivation device 200 performs operation similar to that of the system configuration derivation device 100 of the first example embodiment using output, obtained by inputting an abstract configuration input from the user to the resource data extraction unit 201, directly as input. Thereafter, an abstract configuration, obtained by inputting a set of the abstract configuration and the resource usage status obtained as output to the resource data reflection unit 202, is set as output of the system configuration derivation device 200.

The operation of the resource data extraction unit 201 will be described using a specific example. The resource data extraction unit 201 according to the present example embodiment outputs an abstract configuration and a resource allocation model obtained by applying all applicable resource conversion rules to the input abstract configuration.

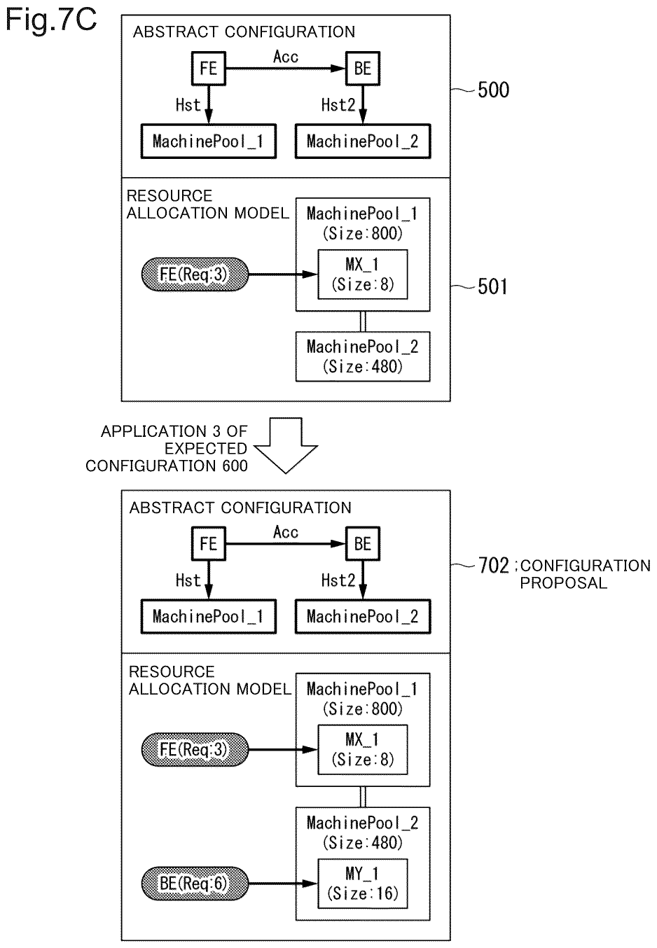

FIG. 9 is a diagram illustrating requirement information before conversion. The requirement information before conversion is represented only by an abstract configuration 900.

The abstract configuration 900 includes seven App type nodes app1, app2, . . . , and app7, and “required memory capacities (GB)” thereof are 6, 5, 4, 2, 1, 4, and 7. The abstract configuration 900 includes 50 MachineX type nodes m1, m2, . . . , and m50, and further includes three Host type edges of “an edge from app1 to m1”, “an edge from app2 to m3”, and “an edge from app5 to m3”.

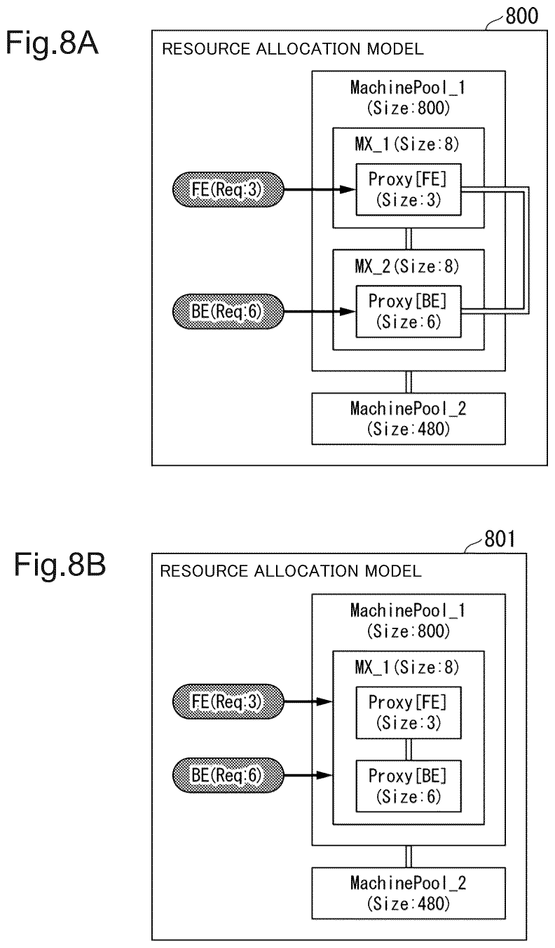

FIG. 10 is a diagram illustrating a configuration proposal obtained by applying the resource conversion rule “Convert-XResource” to the abstract configuration 900 by the resource data extraction unit 201. The “configuration proposal” illustrated in FIG. 10 includes an abstract configuration 1000 and a resource allocation model 1001.

In the resource allocation model 1001, a resource group pool_mx having resources 1, 2, . . . , and 400 is added by step (1) of Convert-XResource.

In the resource allocation model 1001, consumers app1, app2, . . . , and app7 whose required resource amounts are 6, 5, 4, 2, 1, 4, and 7, respectively, are added by the step (2) of Convert-XResource, and resource groups m1 and m2 each having a size of 8 are added. In addition, inclusion relationships m1⊆pool_mx and m2⊆pool_mx and consumption relationships app1→m1, app2→m2, and app5→m2 are added.

In the resource allocation model 1001, a disjoint relationship m1≠m2 is added by step (3) of Convert-XResource.

A MachineXPool type node pool_mx is added to the abstract configuration 1000 by step (4) of Convert-XResource, and ends of all three Host type edges included in the abstract configuration 900 are changed to pool_mx.

In the abstract configuration 1000, all of 50 MachineX type nodes included in the abstract configuration 900 are removed by the step (5) of Convert-XResource.

The operation of the resource data extraction unit 201 has been described using the specific example.

Next, operation of the resource data reflection unit 202 will be described using a specific example. The resource data reflection unit 202 receives a set of an abstract configuration and a resource usage status as input, and reflects the resource usage status in the abstract configuration to generate and output an abstract configuration in which a relationship between a resource and a consumer (an entity corresponding to the resource) is represented as concrete node and edge.

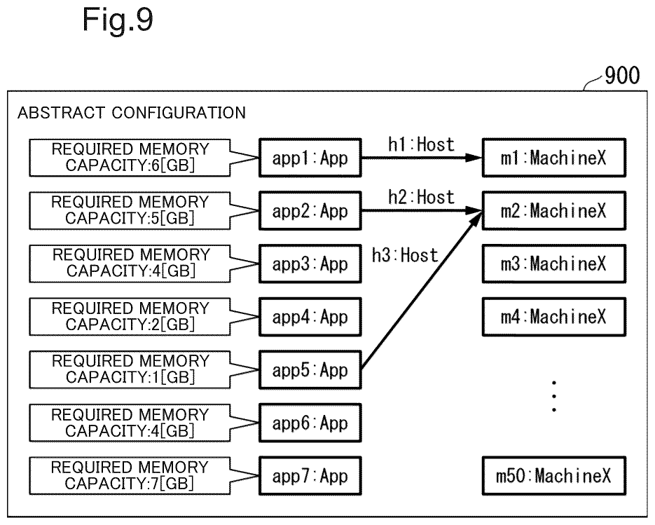

FIG. 11 is a diagram illustrating an abstract configuration 1100 and a resource usage status 1101 as an example of input of the resource data reflection unit 202.

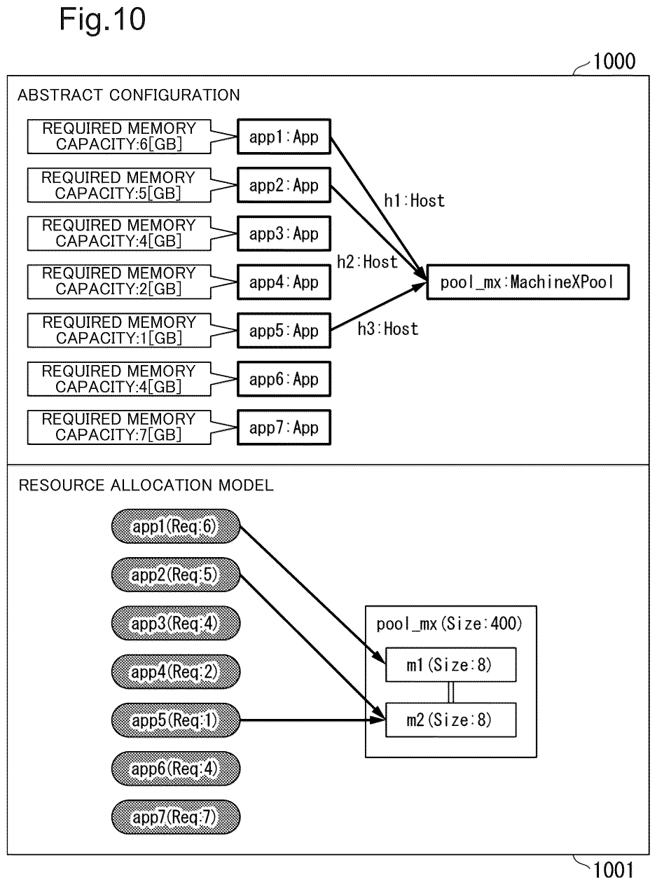

An abstract configuration 1200 of FIG. 12 is a diagram illustrating an abstract configuration obtained by reflecting the resource usage status 1101 in the abstract configuration 1100 by applying the configuration conversion rule Invert-XResource by the resource data reflection unit 202.

The MachineX type nodes m1, m2, m3, and m4 are added to the abstract configuration 1200 by step (1) of Invert-XResource. This is a result of generation of nodes corresponding to resources since resources allocated to app1 are included in m1, resources allocated to app2, app4, and app5 are included in m2, resources allocated to app3 and app6 are included in m3, and resources allocated to app7 are included in m4 in the resource usage status 1101.

In the abstract configuration 1200, the end points of the Host type edges are changed to the MachineX type nodes m1, m2, m3, and m4 by step (1) of Invert-XResource.

From the abstract configuration 1200, the MachineXPool type node pool_mx is deleted by step (2) of Invert-XResource.

### Effects

The system configuration derivation device 200 of the present example embodiment is different from the system configuration derivation device 100 in that data exchange with the user is completed using an abstract configuration.

The resource data extraction unit 201 of the present example embodiment v determine, on behalf of the user, which portion of requirement information given by the user are possible to be efficiently treated as resources.

Therefore, according to the system configuration derivation device 200 of the present example embodiment, it is possible to execute a design process using a resource allocation model after automatically converting resources included in the abstract configuration into the resource allocation model, and as a result, it is possible to automatically design a system configuration at a high speed without causing the user to explicitly specify the presence of the resources.

### Third Example Embodiment

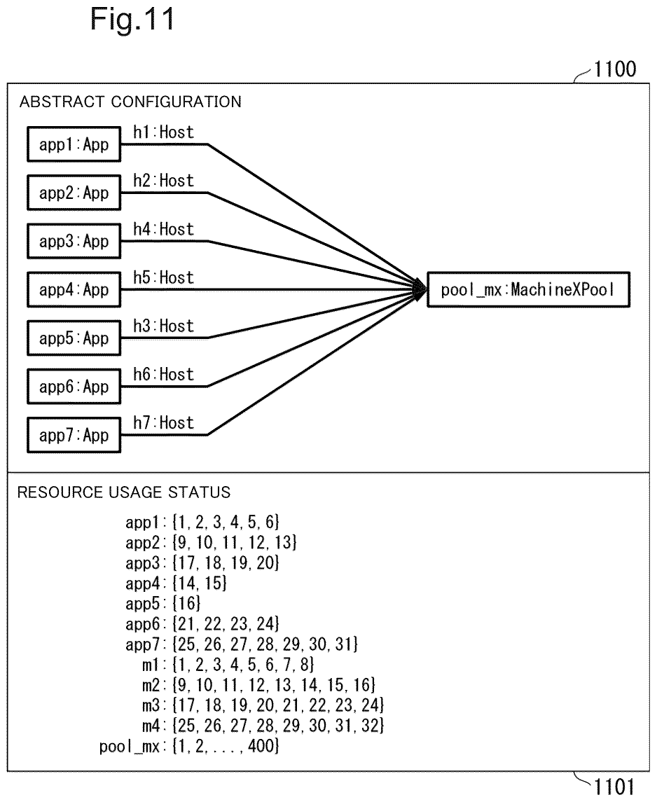

FIG. 13 is a block diagram illustrating a configuration example of a system configuration derivation device according to a third example embodiment.

A system configuration derivation device 80 includes: a concretization means 81 for concretizing an abstract configuration and a resource allocation model input as requirement data in a stepwise manner in accordance with a predetermined rule to generate a system configuration satisfying the requirement data; and an allocation means 82 for receiving the resource allocation model as input and outputting a resource usage status in accordance with the resource allocation model, in a case where the abstract configuration is a configuration information of a system capable of including a configuration that is abstract and represented as graph data connecting a node and an edge, resources is a various resources such as a system resource, an address, a port, a band, and a license required for normal operation of a constituent element of the system, a consumer is the constituent element requiring the resource, a resource group is an object corresponding to a set of the resources, the resource usage status is a data defining the resource used by the consumer and the resources included in the resource group, and the resource allocation model is a data indicating a correspondence between the consumer included in the abstract configuration and the resource group to be allocated to the consumer.

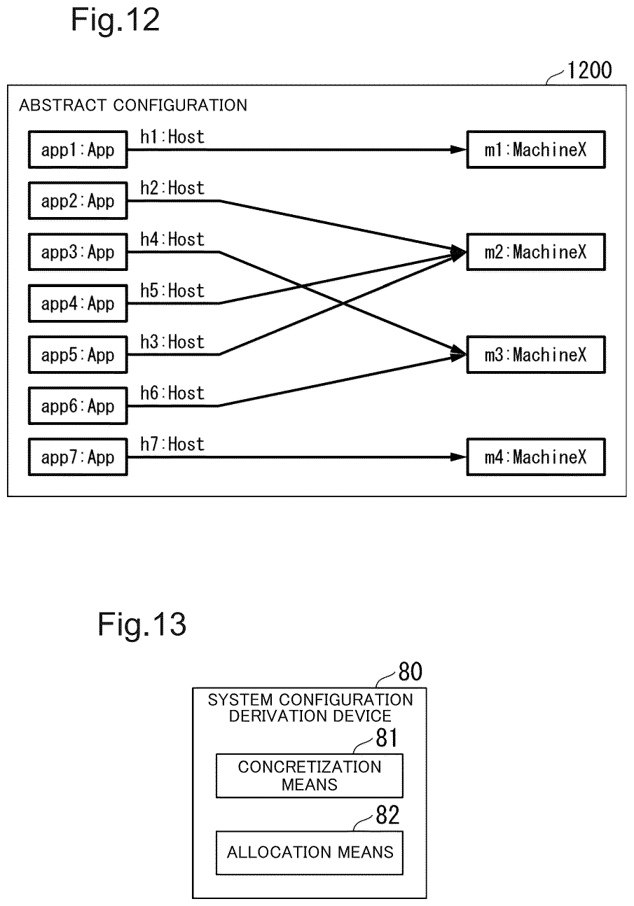

FIG. 14 is a flowchart illustrating an example of operation of the system configuration derivation device according to the third example embodiment.

The concretization means 81 concretizes the abstract configuration and the resource allocation model input as the requirement data in a stepwise manner in accordance with the predetermined rule to generate the system configuration that satisfies the requirement data (step S801). Next, the allocation means 82 receives the resource allocation model as input, and outputs the resource usage status in accordance with the resource allocation model (step S802).

Assuming that an entity that uses the resources in the system configuration is referred to as a “consumer”, in order to solve the above-described problems, it is necessary to devise to represent a set of resources not by a set of individual entities but by a more efficient data structure while appropriately managing information on a relationship between the consumer and the resources.

Therefore, the present disclosure solves the above problems, and provides a technique for efficiently deriving configuration information of a system that handles a large amount of resources. According to the present disclosure, it is possible to efficiently derive the configuration information of the system that handles a large amount of resources.

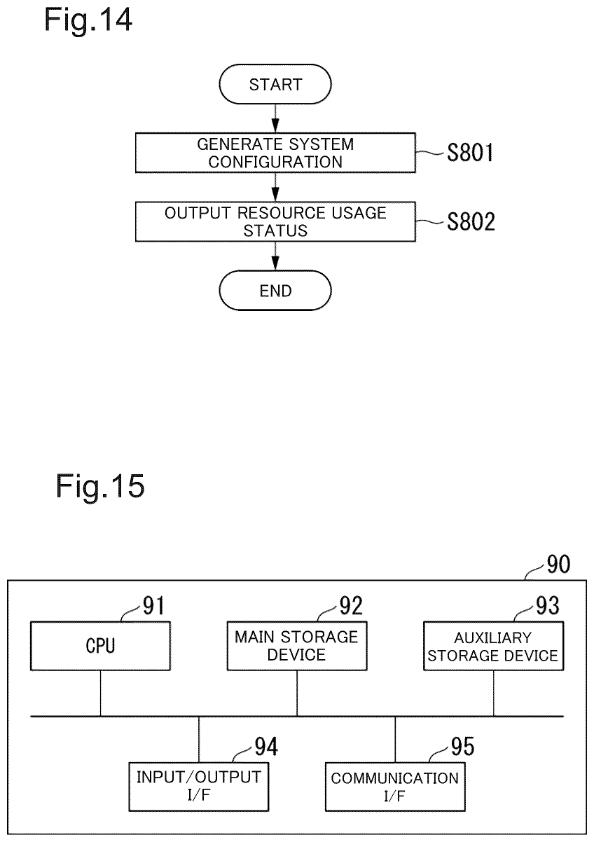

FIG. 15 is a diagram illustrating an example of a hardware configuration of the system configuration derivation device according to each example embodiment.

A computer 90 includes a CPU 91, a main storage device 92, an auxiliary storage device 93, an input/output interface 94, and a communication interface 95. The system configuration derivation devices 100, 200, and 80 described above are implemented in the computer 90. Each function described above is stored in the auxiliary storage device 93 in the form of a program. The CPU 91 reads the program from the auxiliary storage device 93, loads the program in the main storage device 92, and executes the above processing according to the program. The CPU 91 secures a storage area in the main storage device 92 according to the program. The CPU 91 secures a storage area for storing data being processed in the auxiliary storage device 93 according to the program.

A program for implementing all or part of the functions of the system configuration derivation devices 100, 200, and 80 may be recorded in a computer-readable recording medium, and the processing of each functional unit may be performed by causing a computer system to read and execute the program recorded in the recording medium. The “computer system” here includes hardware such as an OS and peripheral devices. The “computer system” is assumed to include a home page provision environment (or display environment) when the WWW system is used.

The “computer-readable recording medium” refers to a portable medium such as a CD, a DVD, or a USB, or a storage device such as a hard disk built in a computer system. In a case where this program is distributed to the computer 90 via a communication line, the computer 90 that has received the distribution may expand the program in the main storage device 92 and execute the above processing. The program may be for implementing a part of the functions described above, and the functions described above may be achieved in combination with a program already recorded in the computer system.

Although one example embodiment of the present disclosure has been described in detail with reference to the drawings, the specific configuration is not limited to the above, and various design changes and the like can be made without departing from the gist of the present disclosure. One aspect of the present disclosure is possible to be variously modified within the scope indicated in the claims, and example embodiments obtained by appropriately combining the technical means disclosed in the different example embodiments are also included in the technical scope of the present disclosure. A configuration in which the elements that are described in each of the above example embodiments and modifications and that have similar effects are replaced with each other is also included. Each example embodiment is possible to be appropriately combined with another example embodiment.

Some or all of the above example embodiments may be described as the following Supplementary Notes, but are not limited to the following.

### (Supplementary Note 1)

A system configuration derivation device comprising:
a memory; and
at least one processor coupled to the memory,
the at least one processor performing operations to:
acquire an abstract configuration and a resource allocation model input as requirement data and concretize the abstract configuration and the resource allocation model in a stepwise manner in accordance with a predetermined rule to generate a system configuration satisfying the requirement data; and
acquire the resource allocation model as input and output a resource usage status in accordance with the resource allocation model,
in a case where the abstract configuration is a configuration information of a system capable of including a configuration that is abstract and represented as graph data connecting a node and an edge,
a resource is a resource required for normal operation of a constituent element of the system,
a consumer is the constituent element requiring the resource, a resource group refers to an object corresponding to a set of the resources,
the resource usage status is a data defining the resource used by the consumer and the resources included in the resource group, and
the resource allocation model is a data indicating a correspondence between the consumer included in the abstract configuration and the resource group to be allocated to the consumer.

### (Supplementary Note 2)

The system configuration derivation device according to Supplementary Note 1, wherein the at least one processor further performs operation to:
a resource data extraction unit configured to acquire the abstract configuration as input and perform a conversion operation of extracting a portion being efficiently treatable as the resource to output the abstract configuration in which a portion corresponding to the resource is abstracted and the resource allocation model representing the extracted portion corresponding to the resource.

### (Supplementary Note 3)

The system configuration derivation device according to Supplementary Note 1 or 2, wherein the at least one processor further performs operation to:
a resource data reflection unit configured to acquire the abstract configuration and the resource usage status as input and reflect information on the resource usage status in the abstract configuration to generate the abstract configuration in which the resource required by the consumer included in the abstract configuration is concretized.

### (Supplementary Note 4)

The system configuration derivation device according to any one of Supplementary Notes 1 to 3, wherein the at least one processor further performs operation to:
convert the input resource allocation model into a constraint problem for an integer variable, and obtains a solution of the constraint problem to calculate the resource usage status.

### (Supplementary Note 5)

The system configuration derivation device according to Supplementary Note 4, wherein the constraint problem includes a constraint that a quantity of the resources allocated to the consumer is equal to a required resource amount of the consumer, a constraint that a quantity of the resources allocated to the resource group in which capacity of the resources is defined is equal to the capacity of the resources defined in the resource group, a constraint that the resources allocated to the consumers, different from one another, do not overlap, a constraint that the resources allocated to the resource groups, which are different from one another and have a disjoint relationship, do not overlap, a constraint that the resources respectively allocated to the resource groups having an inclusion relationship satisfy the inclusion relationship, and a constraint that the resource allocated to the consumer is included in the resource group when the consumer and the resource group have a relationship in which the consumer consumes the resource group.

### (Supplementary Note 6)

A system configuration derivation method including:
acquiring, by a computer, an abstract configuration and a resource allocation model input as requirement data, and concretizing the abstract configuration and the resource allocation model in a stepwise manner in accordance with a predetermined rule to generate a system configuration satisfying the requirement data;
and acquiring, by the computer, the resource allocation model as input and outputting a resource usage status in accordance with the resource allocation model,
in a case where the abstract configuration is a configuration information of a system capable of including a configuration that is abstract and represented as graph data connecting a node and an edge,
a resource is a resource required for normal operation of a constituent element of the system, a consumer refers to the constituent element requiring the resource,
a resource group is an object corresponding to a set of the resources,
the resource usage status is a data defining the resource used by the consumer and the resources included in the resource group,
and the resource allocation model is a data indicating a correspondence between the consumer included in the abstract configuration and the resource group to be allocated to the consumer.

### (Supplementary Note 7)

A non-transitory computer-readable recording medium storing a program causing a computer to execute processing of:
acquiring, by a computer, an abstract configuration and a resource allocation model input as requirement data, and concretizing the abstract configuration and the resource allocation model in a stepwise manner in accordance with a predetermined rule to generate a system configuration that satisfies the requirement data; and
acquiring, by the computer, the resource allocation model as input and outputting a resource usage status in accordance with the resource allocation model,
in a case where an abstract configuration is a configuration information of a system capable of including a configuration that is abstract and represented as graph data connecting a node and an edge,
a resource is a resource required for normal operation of a constituent element of the system, a consumer refers to the constituent element requiring the resource,
a resource group is an object corresponding to a set of the resources, the resource usage status refers to data defining the resource used by the consumer and the resources included in the resource group, and
the resource allocation model is a data indicating a correspondence between the consumer included in the abstract configuration and the resource group to be allocated to the consumer.

1. A system configuration derivation device comprising:
a memory; and
at least one processor coupled to the memory,
the at least one processor performing operations to:
acquire an abstract configuration and a resource allocation model input as requirement data and concretize the abstract configuration and the resource allocation model in a stepwise manner in accordance with a predetermined rule to generate a system configuration satisfying the requirement data; and
acquire the resource allocation model as input and output a resource usage status in accordance with the resource allocation model,
in a case where the abstract configuration is a configuration information of a system capable of including a configuration that is abstract and represented as graph data connecting a node and an edge,
a resource is a resource required for normal operation of a constituent element of the system,
a consumer is the constituent element requiring the resource,
a resource group is an object corresponding to a set of the resources,
the resource usage status is a data defining the resource used by the consumer and the resources included in the resource group, and
the resource allocation model is a data indicating a correspondence between the consumer included in the abstract configuration and the resource group to be allocated to the consumer.

2. The system configuration derivation device according to claim 1, wherein the at least one processor further performs operation to:
acquire the abstract configuration as input and perform a conversion operation of extracting a portion being efficiently treatable as the resource to output the abstract configuration in which a portion corresponding to the resource is abstracted and the resource allocation model representing the extracted portion corresponding to the resource.

3. The system configuration derivation device according to claim 1, wherein the at least one processor further performs operation to: acquire the abstract configuration and the resource usage status as input and reflect information on the resource usage status in the abstract configuration to generate the abstract configuration in which the resource required by the consumer included in the abstract configuration is concretized.

4. The system configuration derivation device according to claim 1, wherein the at least one processor further operation to
convert the input resource allocation model into a constraint problem on an integer variable, and obtains a solution of the constraint problem to calculate the resource usage status.

5. The system configuration derivation device according to claim 4, wherein
the constraint problem includes
a constraint that a quantity of the resources allocated to the consumer is equal to a required resource amount of the consumer,
a constraint that a quantity of the resources allocated to the resource group in which capacity of the resources is defined is equal to the capacity of the resources defined in the resource group,
a constraint that the resources allocated to the consumers, different from one another, do not overlap,
a constraint that the resources allocated to the resource groups, which are different from one another and have a disjoint relationship, do not overlap,
a constraint that the resources respectively allocated to the resource groups having an inclusion relationship satisfy the inclusion relationship, and
a constraint that the resource allocated to the consumer is included in the resource group when the consumer and the resource group have a relationship in which the consumer consumes the resource group.

6. A system configuration derivation method comprising:
acquiring, by a computer, an abstract configuration and a resource allocation model input as requirement data, and concretizing the abstract configuration and the resource allocation model in a stepwise manner in accordance with a predetermined rule to generate a system configuration satisfying the requirement data; and
acquiring, by the computer, the resource allocation model as input and outputting a resource usage status in accordance with the resource allocation model,
in a case where the abstract configuration is a configuration information of a system capable of including a configuration that is abstract and represented as graph data connecting a node and an edge,
a resource is a resource required for normal operation of a constituent element of the system,
a consumer is the constituent element requiring the resource,
a resource group is an object corresponding to a set of the resources,
the resource usage status is a data defining the resource used by the consumer and the resources included in the resource group, and
the resource allocation model is a data indicating a correspondence between the consumer included in the abstract configuration and the resource group to be allocated to the consumer.

7. The system configuration derivation method according to claim 6, further comprising
acquiring the abstract configuration as input and perform a conversion operation of extracting a portion being efficiently treatable as the resource to output the abstract configuration in which a portion corresponding to the resource is abstracted and the resource allocation model representing the extracted portion corresponding to the resource.

8. The system configuration derivation method according to claim 6, further comprising
acquiring the abstract configuration and the resource usage status as input and reflect information on the resource usage status in the abstract configuration to generate the abstract configuration in which the resource required by the consumer included in the abstract configuration is concretized.

9. The system configuration derivation method according to claim 6, further comprising
converting the input resource allocation model into a constraint problem on an integer variable, and obtaining a solution of the constraint problem to calculate the resource usage status.

10. The system configuration derivation method according to claim 9, wherein
the constraint problem includes
a constraint that a quantity of the resources allocated to the consumer is equal to a required resource amount of the consumer,
a constraint that a quantity of the resources allocated to the resource group in which capacity of the resources is defined is equal to the capacity of the resources defined in the resource group,
a constraint that the resources allocated to the consumers, different from one another, do not overlap,
a constraint that the resources allocated to the resource groups, which are different from one another and have a disjoint relationship, do not overlap,
a constraint that the resources respectively allocated to the resource groups having an inclusion relationship satisfy the inclusion relationship, and
a constraint that the resource allocated to the consumer is included in the resource group when the consumer and the resource group have a relationship in which the consumer consumes the resource group.

11. A non-transitory computer-readable recording medium storing a program causing a computer to execute processing of:
acquiring, by a computer, an abstract configuration and a resource allocation model input as requirement data, and concretizing the abstract configuration and the resource allocation model in a stepwise manner in accordance with a predetermined rule to generate a system configuration that satisfies the requirement data; and
acquiring, by the computer, the resource allocation model as input and outputting a resource usage status in accordance with the resource allocation model,
in a case where the abstract configuration is a configuration information of a system capable of including a configuration that is abstract and represented as graph data connecting a node and an edge,
a resource is a resource required for normal operation of a constituent element of the system,
a consumer is the constituent element requiring the resource,
a resource group refers to an object corresponding to a set of the resources,
the resource usage status is a data defining the resource used by the consumer and the resources included in the resource group, and
the resource allocation model is a data indicating a correspondence between the consumer included in the abstract configuration and the resource group to be allocated to the consumer.

12. The non-transitory computer-readable recording medium according to claim 11, further comprising
acquiring the abstract configuration as input and perform a conversion operation of extracting a portion being efficiently treatable as the resource to output the abstract configuration in which a portion corresponding to the resource is abstracted and the resource allocation model representing the extracted portion corresponding to the resource.

13. The non-transitory computer-readable recording medium according to claim 11, further comprising
acquiring the abstract configuration and the resource usage status as input and reflect information on the resource usage status in the abstract configuration to generate the abstract configuration in which the resource required by the consumer included in the abstract configuration is concretized.

14. The non-transitory computer-readable recording medium according to claim 11 further comprising
converting the input resource allocation model into a constraint problem on an integer variable, and obtaining a solution of the constraint problem to calculate the resource usage status.

15. The non-transitory computer-readable recording medium according to claim 14, wherein
the constraint problem includes
a constraint that a quantity of the resources allocated to the consumer is equal to a required resource amount of the consumer,
a constraint that a quantity of the resources allocated to the resource group in which capacity of the resources is defined is equal to the capacity of the resources defined in the resource group,
a constraint that the resources allocated to the consumers, different from one another, do not overlap,
a constraint that the resources allocated to the resource groups, which are different from one another and have a disjoint relationship, do not overlap,
a constraint that the resources respectively allocated to the resource groups having an inclusion relationship satisfy the inclusion relationship, and
a constraint that the resource allocated to the consumer is included in the resource group when the consumer and the resource group have a relationship in which the consumer consumes the resource group.
